(19) United States
(12) Patent Application Publication
(10) Pub. No.: US 2013/0189870 A1
(43) Pub. Date: Jul. 25, 2013

(54) CONNECTOR

(71) Applicants: TOYOTA BOSHOKU KABUSHIKI KAISHA, Kariya-shi (JP); HOSIDEN CORPORATION, Yao-shi (JP)

(72) Inventors: Fumitoshi AKAIKE, Miyoshi-shi (JP); Atsushi ISHII, Nagoya-shi (JP); Yuuki KAWABATA, Toyota-shi (JP); Shinichi MASAMOTO, Nagoya-shi (JP); Takashi SHIMIZU, Yao-shi (JP); Akihiro TANAKA, Yao-shi (JP)

(73) Assignees: HOSIDEN CORPORATION, Osaka (JP); TOYOTA BOSHOKU KABUSHIKI KAISHA, Kariya-shi (JP)

(21) Appl. No.: 13/732,592

(22) Filed: Jan. 2, 2013

(30) Foreign Application Priority Data
Jan. 6, 2012 (JP) 2012-001535
May 21, 2012 (JP) 2012-115307

(51) Int. Cl. H01R 13/627

(52) U.S. Cl. CPC H01R 13/627
USPC 439/345

(57) ABSTRACT

A connector of the invention includes first and second conducting parts and a coupling part. The coupling part couples ends of the first and second conducting parts to allow the first and second conducting parts to turn from a closed position, in which the first and second conducting parts sandwich therebetween a conductor having flexibility, to an open position, in which the first and second conducting parts release the conductor. At least one of the first and second conducting parts includes a locking projection. The locking projection is configured to swing in accordance with the turning of the one of the conducting parts and pass through the conductor. The locking projection is of a curved form conforming to a swing track of the locking projection.

The present application claims priority under 35 U.S.C. §119 of Japanese Patent Applications No. 2012-1535 filed on Jan. 6, 2012 and No. 2012-115307 filed on May 21, 2012, the disclosure of which is expressly incorporated by reference herein in its entity.

### BACKGROUND OF THE INVENTION

1. Technical Field

The invention relates to connectors connectable to flexible electrical conductors such as electrically conductive cloths.

2. Background Art

Japanese Patent Application Laid-Open (JP-A) Nos. 2001-291536 and 2000-28742 each disclose a conventional connection terminal connectable to an electrically conductive cloth. These connection terminals each have hooks, contacts, and cables. The hooks can be locked in holes provided in the conductive cloth. The hooks are provided with the contacts, which are electrically connectable with the conductive cloth. The cables are connected to the contacts.

### SUMMARY OF INVENTION

In each of the above connection terminals, as it is required to make holes in the conductive cloth, it is difficult to change the connecting positions of the connection terminals with respect to the conductive cloth. In addition, making holes in the conductive cloth may damage the electrodes in the conductive cloth. Consequently, the conventional connection terminals have low connection stability with respect to the conductive cloth.

In view of the above circumstances, the invention provides a connector that is easy to change its connecting position with respect to an electrical conductor and has improved connecting stability with respect to the electrical conductor.

A first connector according to an aspect of the invention includes first and second conducting parts and a coupling part. The coupling part couples ends of the first and second conducting parts to allow the first and second conducting parts to turn from a closed position, in which the first and second conducting parts sandwich therebetween a conductor having flexibility, to an open position, in which the first and second conducting parts release the conductor. At least one of the first and second conducting parts includes a locking projection. The locking projection is configured to swing in accordance with the turning of the one of the conducting parts and pass through the conductor. The locking projection is of a curved form conforming to a swing track of the locking projection.

In the first connector in this aspect, the first and second conducting parts are connected to the conductor by sandwiching the conductor therebetween to make the locking projection pass through the conductor. It is therefore easy to change the connecting positions of the first and second conducting parts with respect to the conductor. In addition, as the locking projection passes through the conductor, there is no need to make a large hole for attaching a hook in the conductor as in the conventional art. Therefore, there is no damaging of an electrode in the conductor due to hole-making, thereby improving the connection stability of the connector with respect to the conductor. Further, the first connector has improved tension strength with respect to the conductor because the locking projection passes through the conductor. Further, the locking projection is of a curved form conforming to its swing tracks. It is therefore possible to reduce load on the conductor when the locking projection sticks into the conductor.

The first connector may further include first and second bodies with insulation properties. The first body may be fixed to the first conducting part and cover the first conducting part. The second body may be fixed to the second conducting part and cover the second conducting part. In the first connector according to this aspect, the first conducting part covered by the first body and the second conducting part covered by the second body ensure insulation between the first and second conducting parts and the periphery thereof. It is therefore possible to reduce the risk of short circuit or the like in the first and second conducting parts.

A second connector of the invention includes first and second conducting parts, first and second bodies, and a coupling part. The first body is fixed to the first conducting part. The second body is fixed to the second conducting part. The coupling part couples ends of the first and second bodies to allow the first and second conducting parts to turn from a closed position, in which the first and second conducting parts sandwich therebetween a conductor having flexibility, to an open position, in which the first and second conducting parts release the conductor. At least one of the first and second conducting parts includes a locking projection. The locking projection is configured to swing in accordance with the turning of the one of the conducting parts and pass through the conductor. The locking projection is of a curved form conforming to a swing track of the locking projection.

In the second connector in this aspect, the first and second conducting parts are connected to the conductor by sandwiching the conductor therebetween to make the locking projection pass through the conductor. It is therefore easy to change the connecting positions of the first and second conducting parts with respect to the conductor. In addition, as the locking projection passes through the conductor, there is no need to make a large hole for attaching a hook in the conductor as in the conventional art. Therefore, there is no damaging of an electrode in the conductor due to hole-making, thereby improving the connection stability of the connector with respect to the conductor. Further, the second connector has improved tension strength with respect to the conductor because the locking projection passes through the conductor. Further, the locking projection is of a curved form conforming to its swing tracks. It is therefore possible to reduce load on the conductor when the locking projection sticks into the conductor.

At least the other one of the first and second conducting parts may include a locking hole or recess to receive the locking projection. In the first and second connectors in this aspect, as the locking projection is received in the locking hole or recess, the first and second connectors have further improved tension strength with respect to the conductor.

At least one of the first and second conducting parts may include a contacting portion configured to resiliently contact the conductor as sandwiched by the first and second conducting parts. In the first and second connectors in this aspect, the contacting portion resiliently contacts the conductor as sandwiched by the first and second conducting parts. Therefore, the first and second conducting parts have improved retaining force and stable contact resistance values with respect to the conductor. Further, the spring constant of the contacting portion can be changed by changing the shape of the contacting portion. Therefore, the first and second connectors under vibration or shock are less likely to produce resonance with the contacting portion.

The one of the conducting parts may be made of an electrically conductive metal plate. The contacting portion may be a resilient piece formed by cutting and raising a portion of the metal plate. As the contacting portion is a resilient piece formed by cutting and raising a portion of the metal plate, the first and second connectors in this aspect can be manufactured with a reduced number of constituents and with reduced costs.

One of the first and second bodies may include an abutment to create a predetermined clearance between the first and second conducting parts by abutting the other one of the first and second bodies with the first and second conducting parts sandwiching the conductor therebetween. In the first and second connectors in this aspect, when the first and second conducting parts sandwich the conductor therebetween, the abutment abuts the other one of the first and second bodies and thereby creates the predetermined clearance between the first and second conducting parts. Therefore, even when an external force is applied to the first and second connectors, the predetermined clearance between the first and second conducting parts can be ensured, ensuring a predetermined connected state between the first and second conducting parts and the conductor.

The first and second connectors may further include a connecting portion connected to at least one of the first and second conducting parts and connectable to a cable. In the first and second connectors in this aspect, the core of the cable is connectable to the connecting portion. It is therefore easy to externally connect the first and second connectors.

The first and second connectors may further include a holding portion configured to hold the cable. In the first and second connectors in this aspect, the cable, held by the holding portion, has improved tension strength.

The first and second connectors may further include a cable connecting part. The cable connecting part may be fixed to the coupling part, which may be electrically conductive. The cable connecting part may include the connecting portion. In the first and second connectors in this aspect, the core of the cable is connectable to the connecting portion of the cable connecting part fixed to the coupling part. It is therefore easy to externally connect the first and second connectors.

The first and second connectors may further include a movable part provided in at least one of the first and second conducting parts. The movable part may approach and abut the connecting portion of the cable connecting part when the first and second conducting parts turn from the open position to the closed position. Abutment of the movable part on the connecting portion may cause the connecting portion of the cable connecting part to be sandwiched between the movable part and the coupling part.

In the first and second connectors in this aspect, when the first and second conducting parts turn from the open position to the closed position, the movable part approaches and abuts the connecting portion of the cable connecting part. This causes the connecting portion of the cable connecting part to be sandwiched between the movable part and the coupling part. It is therefore possible to improve the fixing strength of the cable connecting part with respect to the coupling part, thereby making the cable connecting part more resistant to external load.

At least one of the cable connecting part and the coupling part may include a hook. The other of the cable connecting part and the coupling part may include a locking hole or recess engageable with the hook. In the first and second connectors in this aspect, the hook engaged in the locking hole or recess makes the cable connecting part more resistant to external load. In addition, the cable, whose core is connected to the connecting portion of the cable connecting part, has improved tension strength.

At least one of the cable connecting part and the coupling part may include a first stop. The other of the cable connecting part and the coupling part may include a locking hole or recess engageable with the first stop. In the first and second connectors in this aspect, engaging the first stop in the locking hole or recess causes the cable connecting part to be positioned with respect to the coupling part. It is therefore easy to fix the cable connecting part to the coupling part.

The first and second connectors may further include a lock mechanism. The lock mechanism may be configured to lock the first conducting part to the second conducting part with the first and second conducting parts sandwiching the conductor therebetween. The lock mechanism may further include a lock hole or recess and a lock piece. The lock hole or recess may be provided in one of the first and second conducting parts. The lock piece may be provided in the other one of the first and second conducting parts and configured to be received in the lock hole or recess. The cable connecting part may include a second stop to abut the lock piece. In the first and second connectors in this aspect, bringing the second stop into abutment with the locking piece causes the cable connecting part to be positioned with respect to the coupling part. It is therefore easy to fix the cable connecting part to the coupling part.

The coupling part may include first and second guide projections in spaced relation to each other. The first and second guide projections may be configured to receive the cable connecting part therebetween to guide the cable connecting part to a fixing position with respect to the coupling part. In the first and second connectors in this aspect, the first and second guide projections guide the cable connecting part to the fixing position. It is therefore easy to fix the cable connecting part to the coupling part.

The first and second bodies may have a same shape and may be made of an insulating resin. The first and second bodies may each include first and second ends and first and second arms. The first end may be an end in a first direction of the first and second bodies. The second end may be an end on the opposite side of the first end in the first direction. The first arm may be provided at the first end and extend in a second direction perpendicular to the first direction. The second arm may be provided at the second end and extend in the second direction. The second arm may be provided with a recess. The recess in the second arm of the second body may accommodate at least one of the connecting portion, the holding portion, and the cable.

In the first and second connectors in this aspect, the first and second bodies of the same shape and made of an insulating resin can be formed with a same die. It is therefore possible to reduce the costs of the first and second connectors. Further, the recess in the second arm of the second body functions as an accommodating recess to accommodate at least one of the connecting portion, the holding portion, and the cable.

At least one of the first and second conducting parts may include at least one of a projection and a recess contactable with the conductor. In the first and second connectors in this aspect, as at least one of the projection and the recess contacts the conductor, it is possible to increase the contact area with respect to the conductor and thereby stabilize the contact resistance value of the first and second conducting parts with respect to the conductor. Therefore, it is possible to further stabilize the connection of the first and second connectors.

The at least one of the projection and the recess may be of a quadrangular pyramid shape. In the first and second connectors in this aspect, as the at least one of the projection and the recess has increased surface area, it is possible to stabilize the contact resistance value of the first and second conducting parts with respect to the conductor. Therefore, it is possible to stabilize the connection of the first and second connectors.

There may be a plurality of locking projections provided at the center and opposite ends of the first conducting part.

The locking projection may be provided with a barb. In the first and second connectors in this aspect, the barb prevents the locking projection from falling off of the conductor. It is therefore possible to improve the tension strength with respect to the conductor. In addition, the barb may be engaged in a locking hole or recess, in which case the first and second conducting parts have further improved holding force with respect to the conductor. It is therefore possible to reduce the risk of the first and second conducting parts accidentally turning from the closed position to the open position.

At least one of the first and second conducting parts may include a rib or a concave-convex face. In the first and second connectors in this aspect, the rib or the concave-convex face improves the strength of at least one of the first and second conducting parts.

The first and second connectors may further include a lock mechanism. The lock mechanism may be configured to lock the first conducting part to the second conducting part with the first and second conducting parts sandwiching the conductor therebetween. In the first and second connectors in this aspect, the lock mechanism locks the first conducting part to the second conducting part, maintains the first and second conducting parts as sandwiching the conductor therebetween. It is therefore possible to reduce the risk of the first and second conducting parts accidentally turning from the closed position to the open position.

The lock mechanism may include a lock lug and a lock hole or recess. The lock lug may be provided in one of the first and second conducting parts. The lock hole or recess may be provided in the other one of the first and second conducting parts to lock the lock lug therein with the first and second conducting parts sandwiching the conductor therebetween. In the first and second connectors in this aspect, the first and second conducting parts as sandwiching the conductor therebetween can be easily locked simply by locking the lock lug in the locking hole or recess.

The lock mechanism may include a lock hole or recess and a lock piece. The lock hole or recess may be provided in one of the first and second conducting parts. The lock piece may be provided in the other one of the first and second conducting parts and received in the lock hole or recess. The lock piece may be bendable. In the first and second connectors in this aspect, the first and second conducting parts as sandwiching the conductor therebetween can be easily locked simply by inserting the locking piece into the locking hole or recess and bending the locking piece. It is also possible to change the distance between the first and second conducting parts simply by changing the bending position of the lock piece according to the thickness dimension of the conductor.

The lock piece may include a bendable portion and a remaining portion excluding the bendable portion. The bendable portion may have a smaller wall thickness than the remaining portion. In the first and second connectors in this aspect, the locking piece can be easily bent at the bendable portion.

The lock hole or recess may be disposed inward of widthwise ends of the one of the first and second conducting parts. The lock piece may be disposed inward of widthwise ends of the other one of the first and second conducting parts. In the first and second connectors in this aspect, the locking hole or recess and the locking piece are disposed inward of the opposite ends of the first and second conducting parts. Therefore, providing the lock mechanism in the first and second connectors will not cause significant upsizing of the outer dimensions of the first and second connectors.

The lock mechanism may include a lock hole and a lock piece. The lock hole may be provided in one of the first and second conducting parts. The lock piece may be provided in the other one of the first and second conducting parts to be inserted into the lock hole. The lock piece may bifurcate or trifurcate into distal portions that are plastically deformable in directions away from each other and engageable with an edge of the lock hole. In the first and second connectors in this aspect, it is easy to lock the first and second conducting parts as sandwiching the conductor therebetween, simply by inserting the lock piece into the lock hole, plastically deforming the distal portions of the lock piece in directions away from each other, and engaging them with the edge of the lock hole. It is also possible to change the distance between the first and second conducting parts simply by changing the height position of the engagement of the distal portions of the lock piece with respect to the lock hole in accordance with the thickness dimension of the conductor.

The lock hole may be disposed inward of widthwise ends of the one of the first and second conducting parts. The lock piece may be disposed inward of widthwise ends of the other one of the first and second conducting parts. In this aspect of the invention, the locking hole or recess and the locking piece are disposed inward of the opposite ends of the first and second conducting parts. Therefore, providing the lock mechanism in the first and second connectors will not cause significant upsizing of the outer dimensions of the first and second connectors.

### BRIEF DESCRIPTION OF DRAWINGS

FIG. 1A is a front, top, and right side perspective view of a connector according to Embodiment 1 of the invention, in which a cable is connected to the connector and first and second conducting parts are located in an open position;

FIG. 1B is a rear, top, and left side perspective view of the connector, in which the cable is connected to the connector and the first and second conducting parts are located in the open position;

FIG. 2A is a front, top, and right side perspective view of the first and second conducting parts, a coupling part, and the cable connecting part of the connector, in which the first and second conducting parts are located in the open position;

FIG. 2B is a rear, top, and left side perspective view of the first and second conducting parts, the coupling part, and the cable connecting part of the connector, in which the first and second conducting parts are located in the open position;

FIG. 2C is a front, bottom, and left side perspective view of the first and second conducting parts, the coupling part, and the cable connecting part of the connector, in which the first and second conducting parts are located in the open position;

FIG. 2D is a right side view of the first and second conducting parts, the coupling part, and the cable connecting part of the connector, in which the first and second conducting parts are located in the open position;

FIG. 3A is a front, top, and right side perspective view of a body of the connector;

FIG. 3B is a rear, top, and left side perspective view of the body of the connector;

FIG. 4A is a front, top, and right side perspective view of a connector according to Embodiment 2 of the invention, in which a cable is connected to the connector and first and second conducting parts are located in an open position;

FIG. 4B is a rear, top, and left side perspective view of the connector, in which the cable is connected to the connector and the first and second conducting parts are located in the open position;

FIG. 4C is a front, bottom, and left side perspective view of the connector, in which the cable is connected to the connector and the first and second conducting parts are located in the open position;

FIG. 4D is a right side view of the connector, in which the cable is connected to the connector and the first and second conducting parts are located in the open position;

FIG. 5A is a front, top, and right side perspective view of the connector, in which the cable is connected to the connector and the first and second conducting parts are located in a closed position;

FIG. 5B is a right side view of the connector, in which the cable and a conductive cloth are connected to the connector and the first and second conducting parts are located in the closed position;

FIG. 6A is a rear, top, and right side perspective view of a cable connecting part of the connector;

FIG. 6B is a front, bottom, and left side perspective view of the cable connecting part of the connector;

FIG. 7A is a front, top, and right side perspective view of a first modification of the connector, in which the cable connecting part is removed and the first and second conducting parts are located in the open position;

FIG. 7B is a right side view of the modified connector, in which the conductive cloth is connected to the connector and the first and second conducting parts are located in the closed position;

FIG. 8A is a front, top, and right side perspective view of a second modification of the connector, in which the cable is connected to the connector and the first and second conducting parts are located in the open position; and

FIG. 8B is a rear, top, and left side perspective view of the connector, in which the cable is connected to the connector and the first and second conducting parts are located in the open position.

### DESCRIPTION OF EMBODIMENTS

Hereinafter, Embodiments 1 and 2 of the invention will be described.

### Embodiment 1

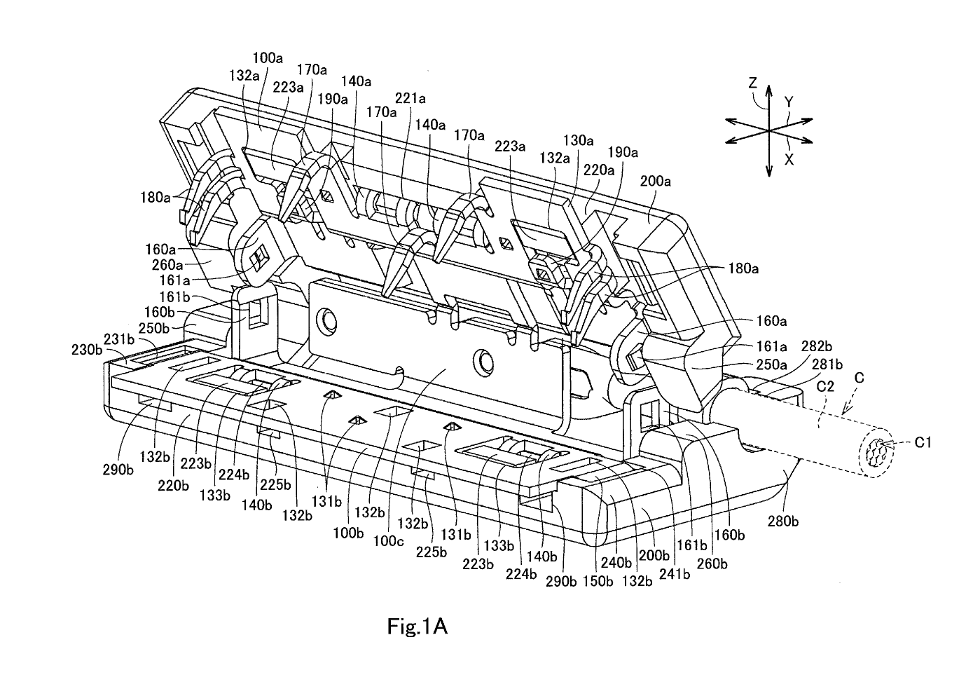

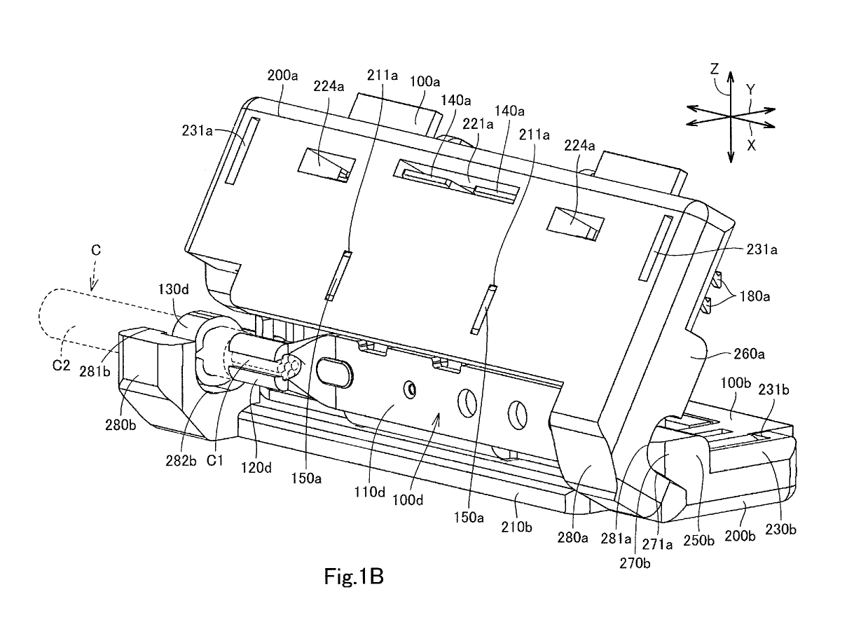

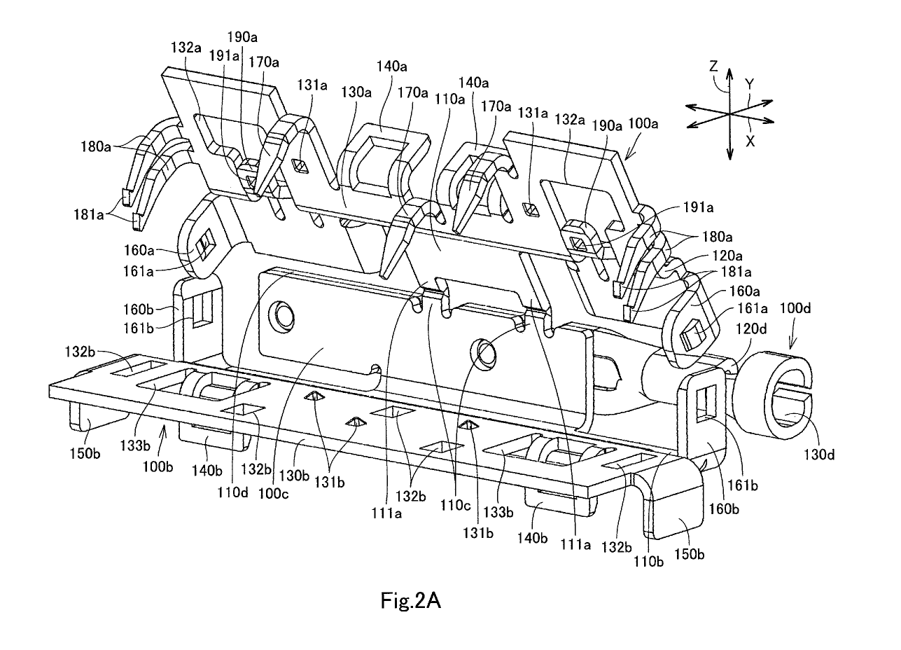

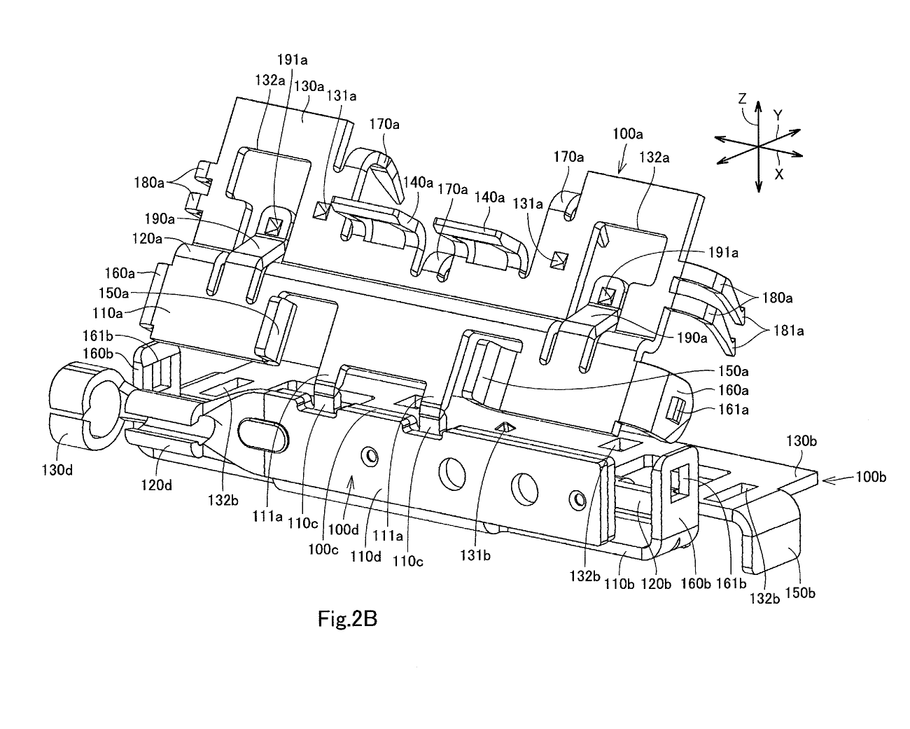

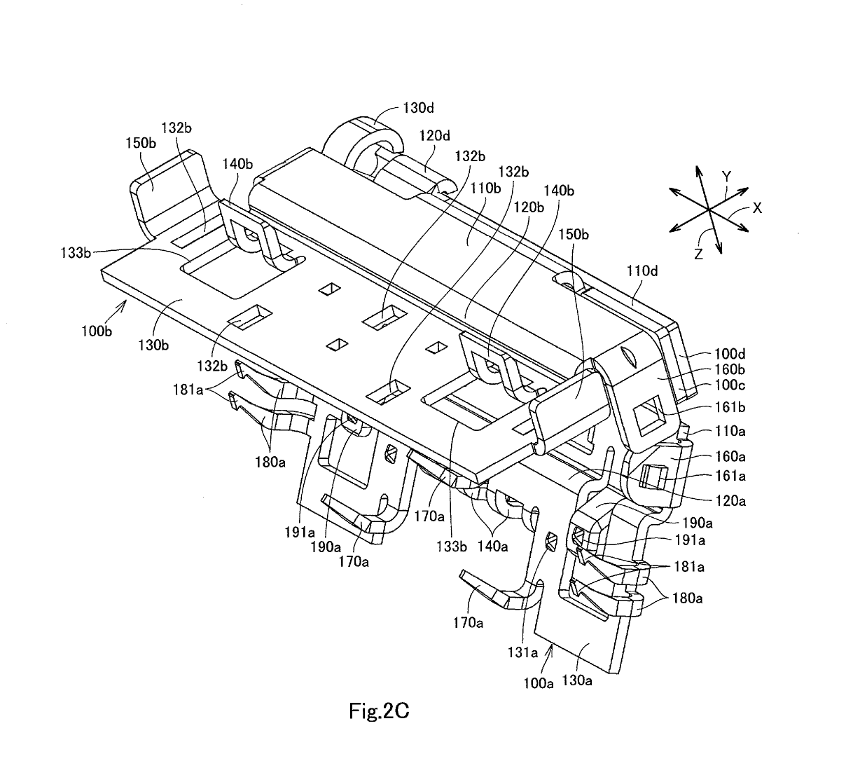

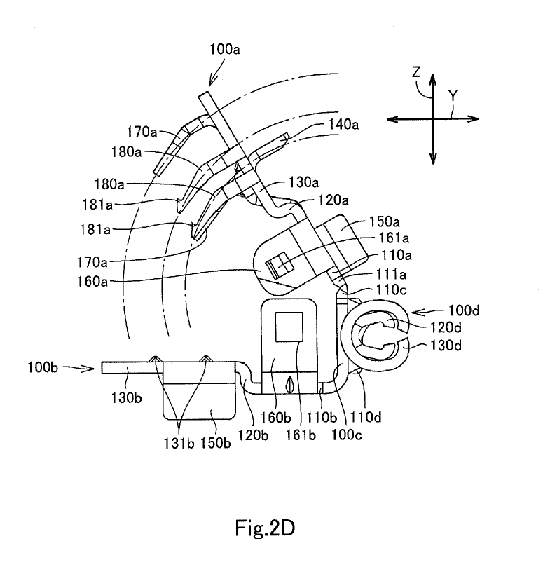

First, a connector according to Embodiment 1 of the invention will be described below with reference to FIGS. 1A to 3B. The connector shown in FIGS. 1A and 1B may be used for connection with a flexible conductive cloth (conductor, not shown). The connector includes a first conducting part 100a, a second conducting part 100b, a coupling part 100c, a cable connecting part 100d, a first body 200a, and a second body 200b. These constituents of the connector will be described below in detail. FIGS. 1A to 2D show directions X, Y, and Z, wherein X is the length direction of the connector, Y is the front-rear direction of the connector, and Z is the height direction of the connector. The Y direction is perpendicular to the X direction, and the Z direction is perpendicular to the X and Y directions.

As shown in FIGS. 2A to 2D, the first conducting part 100a, the second conducting part 100b, and the coupling part 100c are made of a plate of electrically conductive metal. The second conducting part 100b includes a first plate 110b, a second plate 120b, a third plate 130b, a pair of first locking pieces 140b, a pair of second locking pieces 150b, and a pair of third locking pieces 160b (constituent of a lock mechanism).

The first plate 110b is a rectangular plate extending in the X direction and to one side in the Y direction (to the front side). The third locking pieces 160b are joined to opposite ends in the X direction of the first plate 110b. The third locking pieces 160b are plates bent upward (to one side in the Z direction). The third locking pieces 160b are each provided with a rectangular lock hole 161b.

The second plate 120b is a rectangular plate joined to the first plate 110b and bent substantially at a right angle to the first plate 110b to extend toward the first conducting part 100a. The third plate 130b is a rectangular plate joined to the second plate 120b and extends in the X direction and to one side in the Y direction (to the front side). The third plate 130b is bent substantially at a right angle to the second plate 120b so that the first plate 110b and the third plate 130b do not face each other. The third plate 130b is provided at its center with a plurality of projections 131b and a plurality of locking holes 132b. The projections 131b are of quadrangular pyramid shape projecting in the upward direction (to one side in the Z direction). The locking holes 132b are rectangular holes passing through the third plate 130b in the Z direction, and they are arranged in the positions corresponding to locking projections 170a and 180a (to be described) of the first conducting part 100a. The locking holes 132b correspond to the “locking holes” defined in the claims.

The third plate 130b is provided at its opposite ends in the X direction with the first locking pieces 140b. The first locking pieces 140b are formed by cutting and raising portions of the opposite ends downward (to the other side in the Z direction). The first locking pieces 140b are provided with rectangular locking holes. Cutting and raising the first locking pieces 140b leaves holes 133b at opposite ends in the X direction of the third plate 130b. The second locking pieces 150b are joined to respective opposite ends in the X direction of the third plate 130b. The second locking pieces 150b are plates bent downward (to the other side in the Z direction).

The first conducting part 100a includes a first plate 110a, a second plate 120a, a third plate 130a, a pair of first locking pieces 140a, a pair of second locking pieces 150a, a pair of third locking pieces 160a (constituent of the lock mechanism), a plurality of locking projections 170a, a plurality of locking projections 180a, and contacting portions 190a.

The first plate 110a is a rectangular plate extending in the X direction and obliquely upward (in a direction between the one side in the Z direction and the one side in the Y direction). The first plate 110a is provided at its center with a pair of arms 111a. Opposite outer sides of the arms 111a of the first plate 110a are cut and raised to form the second locking pieces 150a. The third locking pieces 160b are plates joined to opposite ends in the X direction of the first plate 110a bent downward. The third locking pieces 160b are provided with lock lugs 161a. The lock lugs 161a can be locked in the lock holes 161b in the second conducting part 100b.

The second plate 120a is a rectangular plate joined to the first plate 110a and bent substantially at a right angle to the first plate 110a to extend toward the second conducting part 100b. The third plate 130a is a plate joined to the second plate 120a and extending in the X direction and obliquely upward. The third plate 130a is bent substantially at a right angle to the second plate 120a so that the first plate 110a and the third plate 130a do not face each other. The third plates 130a and 130b are adapted to securely sandwich the conductive cloth therebetween when the first and second conducting parts 100a and 100b are located in a closed position (to be described).

The central portion of the third plate 130a is cut and raised to form the pair of first locking pieces 140a, which are spaced apart from each other in the X direction. The first locking pieces 140a are each provided with a rectangular locking hole. The locking projections 170a are of pointed shape and joined to the third plate 130a, more particularly to an area between the first locking pieces 140a and areas on either outer side of the first locking pieces 140a of the third plate 130a. The locking projections 170a can swing in accordance with the turning of the first conducting part 100a. As shown in FIG. 2D, the locking projections 170a are bent substantially at right angles to the third plate 130a, and they are of curved forms conforming to their swing tracks. The swing tracks of the locking projections 170a are indicated in dot-dash lines in FIG. 2D.

Projections 131a are provided at the feet of the locking projections 170a at opposite ends of the third plate 130a. The projections 131a are of quadrangular pyramid shape projecting in the same direction as the locking projections 170a. Locking holes 132a are provided on the respective outer sides of the projections 131a of the third plate 130a. The locking holes 132a pass through the third plate 130a. The locking projections 180a are of pointed shape and joined to opposite ends in the X direction of the third plate 130a. The locking projections 180a can swing in accordance with the turning of the first conducting part 100a. As shown in FIG. 2D, the locking projections 180a are bent substantially at right angles to the third plate 130a, and they are of curved forms conforming to their swing tracks. The swing tracks of the locking projections 180a are indicated in dot-dash lines in FIG. 2D. The locking projections 180a are each provided at its end with a barb 181a. The locking projections 170a and 180a are arranged at positions corresponding to the locking holes 132b in the second conducting part 100b (that is, at the center and at the opposite ends of the first conducting part 100a). When the first and second conducting parts 100a and 100b are located in the closed position, the locking projections 170a and 180a pass through the conductive cloth and are received in the locking holes 132b. The barbs 181a can be locked in the locking holes 132b.

The contacting portions 190a are resilient pieces formed by cutting and depressing portions at opposite ends in the X direction of the first plate 110a, the second plate 120a, and the third plate 130a. The contacting portions 190a are bent stepwise such that the lower faces of the distal ends of the contacting portions 190a (the faces facing the second conducting part) are located closer to the second conducting part 100b than the lower face of the third plate 130a (the face facing the second conducting part). Therefore, the contacting portions 190a resiliently contact the conductive cloth sandwiched between the first and second conducting parts 100a and 100b when the first and second conducting parts 100a and 100b are located in the closed position. The contacting portions 190a are each provided at its distal end with a projection 191a. The projections 191a are of quadrangular pyramid shape projecting in the same direction as the locking projections 170a.

The coupling part 100c is a rectangular plate to couple the ends of the first and second conducting parts 100a and 100b such that the first and second conducting parts 100a and 100b are turnable from the closed position to an open position. The coupling part 100c is joined to the rear end (the end on the other side in the Y direction, i.e. the other end in the Y direction) of the first plate 110b of the second conducting part 100b, and it is bent substantially at a right angle to the first plate 110b. The coupling part 100c is provided with a pair of arms 110c extending upward (to the one side in the Z direction). The arms 110c are coupled to the arms 111a of the first conducting part 100a. The boundaries between the arms 110c and the arms 111a are thin-walled. The boundaries serve as pivots on which the first and second conducting parts 100a and 100b turn (open and close) from the closed position to the open position. The first and second conducting parts 100a and 100b in the closed position face each other substantially in parallel and may securely sandwich the conductive cloth therebetween. As shown in FIGS. 1A to 2D, the first and second conducting parts 100a and 100b in the open position are located away from each other, allowing the conductive cloth to be released from therebetween.

As shown in FIG. 2B, the cable connecting part 100d is a plate of electrically conductive metal. The cable connecting part 100d includes a fixed portion 110d, a connecting portion 120d, and a holding portion 130d. The fixed portion 110d is a plate of substantially the same shape as the coupling part 100c, and it is fixed to the rear face of the coupling part 100c. The connecting portion 120d is a generally C-shaped plate joined to the fixed portion 110d, and it is of inside diameter slightly smaller than the outside diameter of a core C1 of a cable C. The connecting portion 120d is adapted to hold the core C1 of the cable C. The holding portion 130d is a generally C-shaped plate joined to the connecting portion 120d, and it is of inside diameter slightly smaller than the outside diameter of an insulative protective cover C2 that covers the core C1 of the cable C. The holding portion 130d is adapted to hold the protective cover C2 of the cable C.

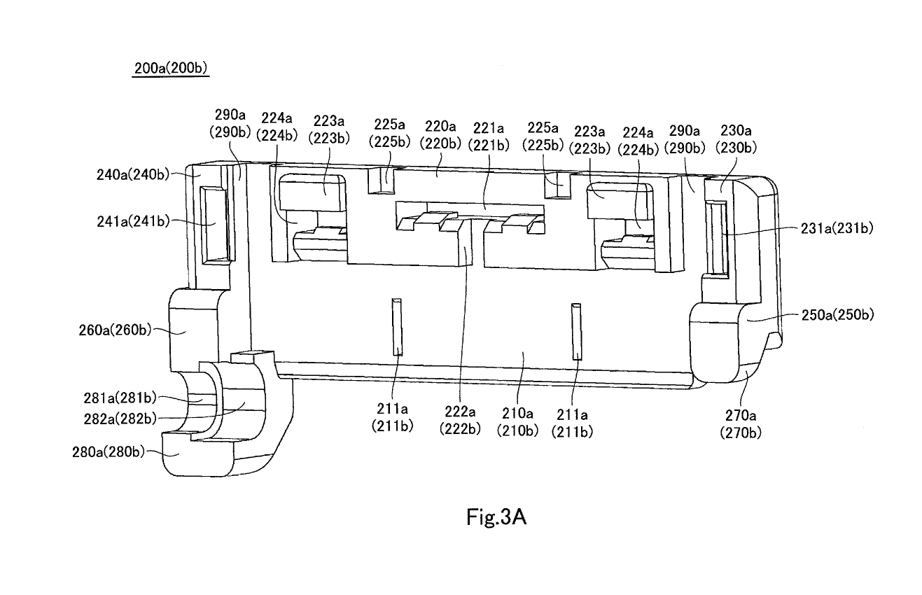

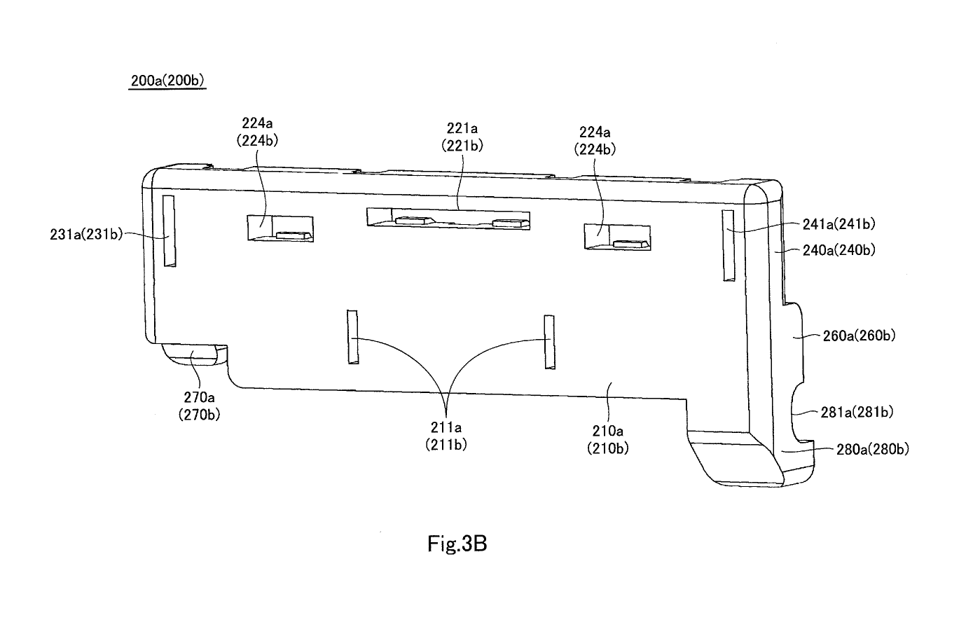

As shown in FIGS. 3A and 3B, the second body 200b is a block of an insulating resin. The second body 200b has a larger dimension in the X direction than the second conducting part 100b. Accordingly, the second body 200b as fixed to the second conducting part 100b (to be described) covers the second conducting part 100b (see FIGS. 1A and 1B). The second body 200b can turn in accordance with the turning of the second conducting part 100b. The second body 200b has a base 210b, a stand 220b, walls 230b and 240b, abutments 250b and 260b, a first arm 270b, and a second arm 280b.

The base 210b is a generally rectangular plate extending in the X direction and to one side in the Y direction (to the front side) and including inner and outer faces. The stand 220b is of rectangular parallelepiped and provided at the center of the distal portion (the one end portion in the Y direction) of the inner face of the base 210b. The stand 220b is provided at its center with a locking hole 221b. The locking hole 221b is a rectangular hole extending in the X direction. On an inner wall of the locking hole 221b, there is provided a pair of lock lugs spaced apart from each other in the X direction. A pair of locking holes 211b extends in the Y direction in the central area of the basal portion of the base 210b (the other end portion in the Y direction).

In opposite ends in the X direction of the stand 220b, there is provided a pair of protrusions 223b and a pair of locking holes 224b. The protrusions 223b are rectangular and project inward of the second body 200b. The locking holes 224b are rectangular and located under the protrusions 223b. The locking holes 224b are provided in their inner walls with lock lugs. The walls 230b and 240b are joined to opposite ends in the X direction of the base 210b. The walls 230b and 240b each have a larger thickness dimension than the base 210b, i.e. the walls 230b and 240b project to the inner face side of the base 210b. The walls 230b and 240b are provided in their distal portions with rectangular locking holes 231b and 241b, respectively.

The protrusions 223b are engaged in the holes 133b of the second conducting part 100b. The locking holes 224b receive the first locking pieces 140b of the second conducting part 100b, and the lock lugs of the locking holes 224b are locked in the locking holes of the first locking piece 140b. The locking holes 231b and 241b fit over the second locking pieces 150b of the second conducting part 100b. The second body 200b is thus fixed to the second conducting part 100b. In this fixed state, the third plate 130b and the first plate 110b of the second conducting part 100b abut the stand 220b and the basal portion, respectively, of the base 210b.

A recess 222b is provided under the locking hole 221b at the center of the stand 220b. The recess 222b extends in the direction perpendicular to the length direction of the locking hole 221b and communicates with the center of the locking hole 221b. The stand 220b also has a pair of recesses 225b, each between the recess 222b and one of the protrusions 223b. In addition, clearances 290b are created between the walls 230b and 240b and the stand 220b. The recesses 222b and 225b and the clearance 290b are located under the locking holes 132b in the second conducting part 100b. When the locking holes 132b in the second conducting part 100b receive the locking projections 170a of the first conducting part 100a, the locking projections 170a at opposite ends are received in the recesses 225b, and the locking projection 170a at the center is received in the recess 222b. When the locking holes 132b in the second conducting part 100b receive the locking projections 180a of the first conducting part 100a, the locking projections 180a are received in the clearances 290b. This arrangement prevents interference between the locking projections 170a and the second body 200b.

The abutments 250b and 260b project from the rear ends of the walls 230b and 240b, respectively. The abutments 250b and 260b project inward of the second body 200b. The first arm 270b is joined to the rear end of the abutment 250b (that is, a first end in the length direction (first direction) of the second body 200b). The first arm 270b extends in the width direction (second direction) of the second body 200b. The first arm 270b has a tapered cross-section getting gradually narrower towards the distal end. The second arm 280b is joined to the rear ends of the base 210b, the wall 240b, and the abutment 260b (i.e., a second end in the length direction (the first direction) of the second body 200b). The second arm 280b extends in the width direction (the second direction) of the second body 200b. The second arm 280b is provided with first and second recess 281b and 282b, which are semi-circular and adjacent to each other in the X direction. The first recess 281b has a smaller inner shape than the second recess 282b. The second recess 282b accommodates a part of the holding portion 130d. The first recess 281b can accommodate a part of the protective cover C2 of cable C. The first recess 281b corresponds to the recess in the second arm of the second body defined in the claims.

As shown in FIGS. 3A and 3B, the first body 200a is a block of insulating resin and has the same shape as the second body 200b. The second body 200a has a larger dimension in the X direction than the first conducting part 100a. Accordingly, the first body 200a as fixed to the first conducting part 100a (to be described) covers the first conducting part 100a (see FIGS. 1A and 1B). The first body 200a can turn in accordance with the turning of the first conducting part 100a. The first body 200a has a base 210a, a stand 220a, walls 230a and 240a, abutments 250a and 260a, a first arm 270a, and a second arm 280a. These portions of the first body 200a will not be described with regard to overlaps with those of the second body 200b.

Locking holes 211a in the base 210a fittingly receive the second locking pieces 150a of the first conducting part 100a. Locking hole 221a in the stand 220a receive the first locking pieces 140a of the first conducting part 100a, and lock lugs in the locking hole 221a are locked in the locking holes in the first locking pieces 140a. Protrusions 223a of the stand 220a are rectangular, project inward of the first body 200a, and are fitted in the respective locking holes 132a in the first conducting part 100a. The first body 200a is thus fixed to the first conducting part 100a. In this fixed state, the third plate 130a of the first conducting part 100a abuts the stand 220a, and the first plate 110a abuts the base end of the base 210a.

Recesses 222a and 225a are located under the locking projections 170a of the first conducting part 100a. Clearances 290a created between the walls 230a and 240a and the stand 220a are located under the locking projections 180a of the first conducting part 100a.

When the first and second conducting parts 100a and 100b are located in the closed position, the abutments 250a and 260a abut the abutments 250b and 260b, respectively. This state creates a predetermined clearance between the third plate 130a of the first conducting part 100a and the third plate 130b of the second conducting part 100b. The clearance is set to be slightly smaller than the thickness dimension of the conductive cloth. Accordingly, the third plate 130a of the first conducting part 100a and the third plate 130b of the second conducting part 100b can securely sandwich the conductive cloth therebetween in a predetermined state in which the first and second conducting parts 100a and 100b are located in the closed position. On the other hand, when the first and second conducting parts 100a and 100b are located in the open position, as shown in FIG. 1B, the first arm 270b of the second body 200b is received in a first recess 281a of the first body 200a. The first recess 281a corresponds to the recess in the second arm of the first body defined in the claims.

Described in detail below are steps to assemble the connector configured as described above and to connect the connector to the connecting cable C. The first step is to prepare the cable connecting part 100d formed by pressing an electrically conductive metal plate. The cable connecting part 100d now have the connecting portion 120d and the holding portion 130d in planar form. The next step is to prepare the cable C, in which one end in the length direction of the protective cover C2 is peeled off to expose the core C1 from the protective cover C2. The exposed core C1 and the protective cover C2 are brought closer to the connecting portion 120d and the holding portion 130d, respectively. The connecting portion 120d is then bent generally in a C-shape and fixedly connected to the core C1. Likewise, the holding portion 130d is bent generally in a C-shape and fixed to the protective cover C2.

The next step is to prepare the first conducting part 100a, the second conducting part 100b, and the coupling part 100c, which are formed by pressing an electrically conductive metal plate. The coupling part 100c is fixed to the fixed portion 110d of the cable connecting part 100d. The core C1 of cable C is thus electrically connected to the first and second conducting parts 100a and 100b via the coupling part 100c.

The next step is to prepare the first body 200a and the second body 200b, formed by injection molding insulating resin. The first locking pieces 140b of the second conducting part 100b are inserted into the locking holes 224b in the second body 200b, while the second locking pieces 150b of the second conducting part 100b are inserted into the locking holes 231b and 241b. The first locking pieces 140b are thus locked in the locking hole 224b, while the second locking pieces 150b are locked in the locking holes 231b and 241b. Simultaneously, the third plate 130b of the second conducting part 100b abuts the stand 220b of the second body 200b, while the first plate 110b of the second conducting part 100b abuts the base end of the base 210b of the second body 200b. The protrusions 223b of the second body 200b are engaged into the holes 133b in the second conducting part 100b. The recesses 222b and 225b and the clearances 290b of the second body 200b are located under and in communication with the associated locking holes 132b. The second recess 282b in the second arm 280b of the second body 200b accommodates a part of the holding portion 130d of the cable connecting part 100d. The first recess 281b accommodates a part of the protective cover C2 of cable C. Consequently, the second body 200b is attached to the second conducting part 100b to cover the rear side of the second conducting part 100b.

On the other hand, the first locking pieces 140a of the first conducting part 100a are inserted into the locking hole 221a in the first body 200a, and the second locking pieces 150a of the first conducting part 100a are inserted into the locking holes 211a in the first body 200a. The first locking pieces 140a are thus locked in the locking hole 221a, while the second locking pieces 150a fit into the locking holes 211a. Simultaneously, the third plate 130a of the first conducting part 100a abuts the stand 220a, the first plate 110a of the first conducting part 100a abuts the base end of the base 210a, and the protrusions 223a of the first body 200a fit into the locking holes 132a in the first conducting part 100a. The distal ends of the contacting portions 190a are located above the locking holes 224a in the first conducting part 100a. Consequently, the first body 200a is attached to the first conducting part 100a to cover the rear side of the first conducting part 100a.

Described below are the steps to connect the conductive cloth to the connector assembled as described above. First, the first and second conducting parts 100a and 100b are brought into the open position. The first body 200a and the second body 200b are accordingly brought into in the open position. Simultaneously, the first arm 270b of the second body 200b is inserted into the first recess 281b in the first body 200a.

Then, the conductive cloth is inserted between the first and second conducting parts 100a and 100b. The next step is to turn the first and second conducting parts 100a and 100b and the first and second bodies 200a and 200b from the open position to the closed position, using the boundaries between the arms 110c and the arms 111a as pivots. The first and second conducting parts 100a and 100b are thus brought closer to each other to sandwich the conductive cloth therebetween. Simultaneously, the locking projections 170a at opposite ends of the first conducting part 100a swing in accordance with the turning of the first conducting part 100a, stick into the conductive cloth, and are received into the locking holes 132b of the second conducting part 100b and then into the recesses 225b in the second body 200b. The other locking projection 170a swings in accordance with the turning of the first conducting part 100a and sticks into the conductive cloth, and is received into the locking hole 132b in the second conducting part 100b and then into the recess 222b in the second body 200b. The locking projections 180a swing in accordance with the turning of the first conducting part 100a, stick into the conductive cloth, and are engagingly received into the locking holes 132b in the second conducting part 100b and then into the clearances 290b in the second body 200b. The contacting portions 190a of the first conducting part 100a resiliently press the conductive cloth onto the third plate 130b of the second conducting part 100b. The projections 191a of the contacting portions 190a thus abut the conductive cloth. The projections 131a of the first conducting part 100a and the projections 131b of the second conducting part 100b also abut the conductive cloth.

In the course of turning the first body 200a and the second body 200b from the open position to the closed position, the first arm 270b of the second body 200b goes out of the first recess 281a of the first body 200a. When the first body 200a and the second body 200b are located in the closed position, the abutments 250a and 260a of the first body 200a abut the abutments 250b and 260b, respectively, of the second body 200b. Also, the lock lugs 161a of the first conducting part 100a are locked in the lock holes 161b in the second conducting part 100b. This locking causes the first and second conducting parts 100a and 100b to be maintained in the closed position, reducing a risk that the first and second conducting parts 100a and 100b may accidentally turn from the closed position to the open position.

In the connector as described above, the first and second conducting parts 100a and 100b are connected to the conductive cloth by sandwiching the conductive cloth therebetween to make the locking projections 170a and 180a pass through the conductive cloth. It is therefore easy to change the connection positions of the first and second conducting parts 100a and 100b with respect to the conductive cloth. In addition, as the locking projections 170a and 180a pass through the conductive cloth, there is no need to make large holes for attaching hooks in the conductive cloth. Therefore, there is no damaging of the electrodes in the conductive cloth due to hole-making, thereby improving the connection stability of the connector with respect to the conductive cloth. Further, the connector has improved tension strength with respect to the conductive cloth because the locking projections 170a and 180a pass through the conductive cloth to be received in the locking holes 132b of the second conducting part 100b. Further, the locking projections 170a and 180a are of curved forms conforming to their swing tracks. It is therefore possible to reduce load on the conductive cloth when the locking projections 170a and 180a stick into the conductive cloth.

Also, when the first and second conducting parts 100a and 100b sandwich the conductive cloth therebetween, the contacting portions 190a of the first conducting part 100a resiliently contact the conductive cloth to press the conductive cloth onto the second conducting part 100b. Therefore, the first and second conducting parts 100a and 100b have an improved retaining force and stable contact resistance values with respect to the conductive cloth. In addition, the conductive cloth as sandwiched between the first and second conducting parts 100a and 100b is in abutment with the projections 191a of the contacting portions 190a and the projections 131a and 131b of the first and second conducting parts 100a and 100b. This abutment increases the contact area with the conductor and thereby stabilizes the contact resistance value of the first and second conducting parts 100a and 100b with respect to the conductive cloth. Further, the spring constant of the contacting portions 190a can be changed by changing the shape of the contacting portions 190a. Therefore, the connector, if under vibration or shock, is unlikely to produce resonance with the contacting portions 190a.

When the first and second conducting parts 100a and 100b sandwich the conductive cloth therebetween, the abutments 250a and 260a of the first body 200a abut the abutments 250b and 260b of the second body 200b, leaving a the predetermined clearance between the first and second conducting parts 100a and 100b. Therefore, even when an external force is applied to the connector, the predetermined clearance between the first and second conducting parts 100a and 100b can be ensured, ensuring a predetermined connected state between the first and second conducting parts 100a and 100b and the conductive cloth.

The first body 200a and the second body 200b are molded articles of insulating resin having the same shape, so that the first and second bodies 200a and 200b can be made with the same die. This results in a reduced cost of the connector. In addition, the second recess 281b in the second body 200b functions as an accommodating recess to accommodates the holding portion 130d of the cable connecting part 100d. On the other hand, the first recess 281 a of the first body 200 in the open position receives the first arm 270b of the second body 200b to avoid interference between the first body 200a and the second body 200b. In this way, the recesses of the second arms of the first body 200a and the second body 200b, having the same shape, serves double duty as an interference avoiding mechanism and accommodating recess.

### Embodiment 2

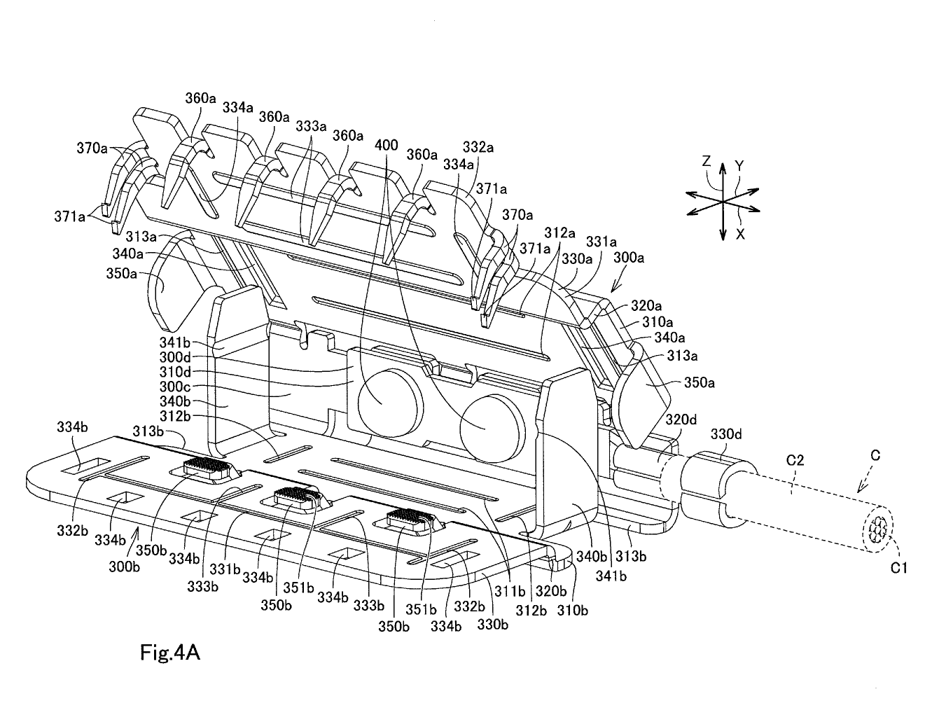

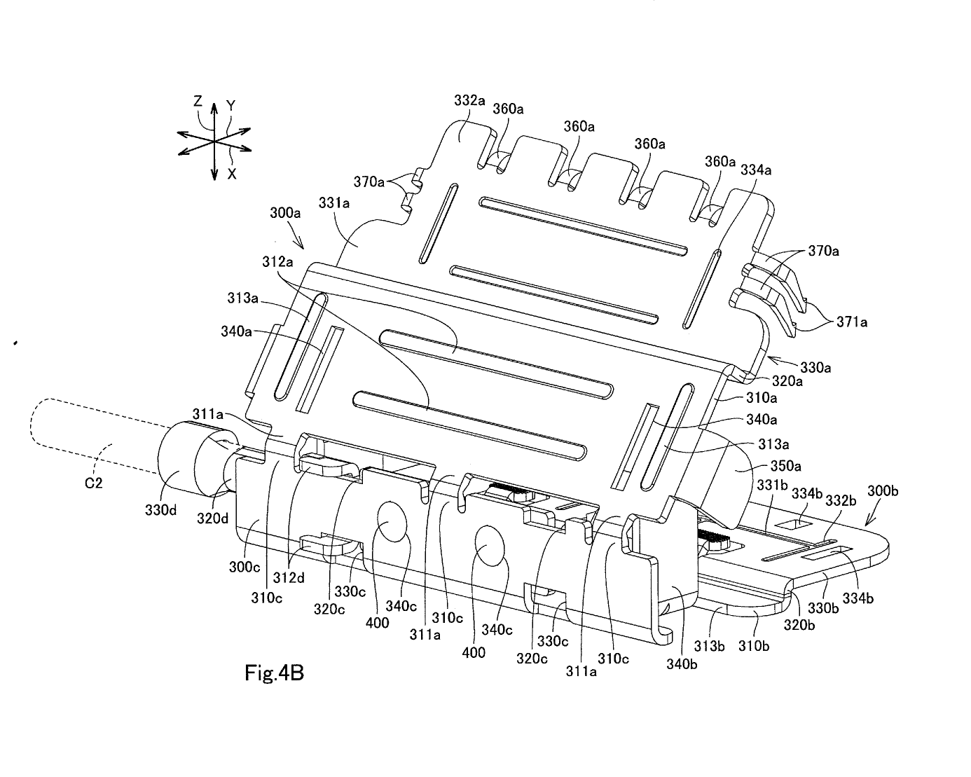

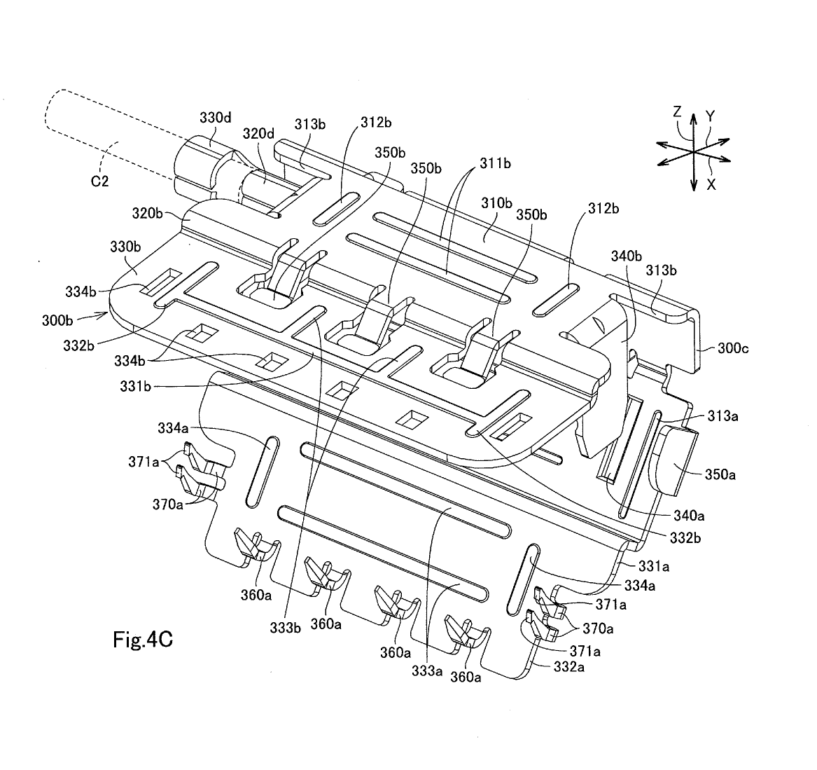

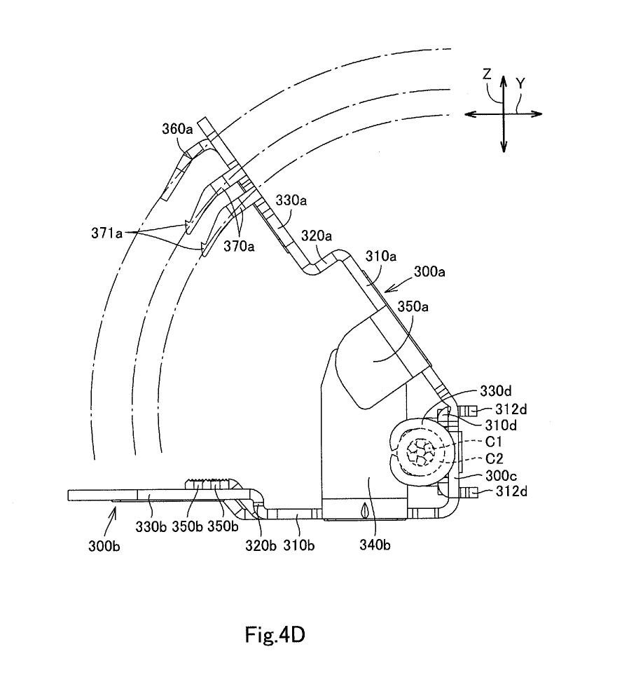

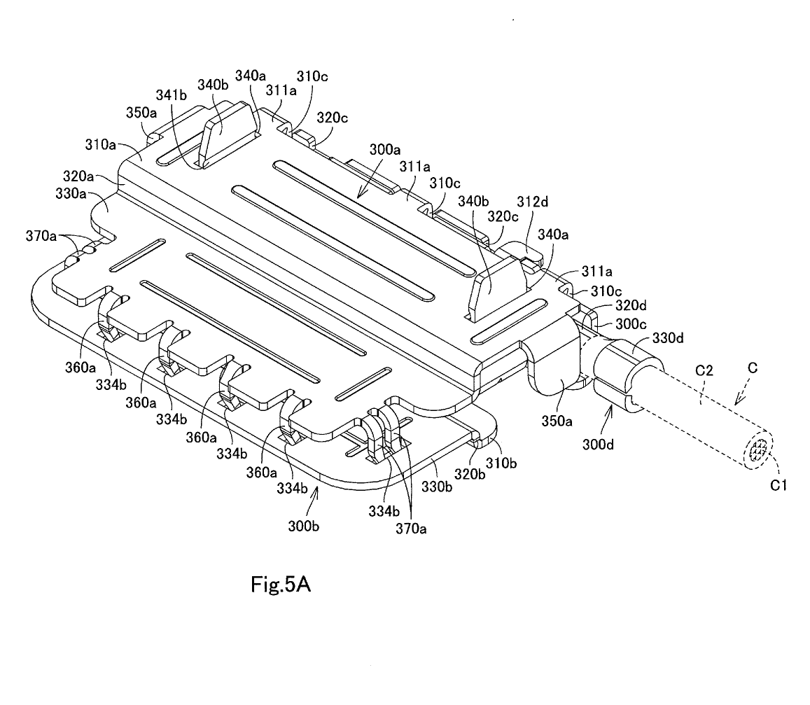

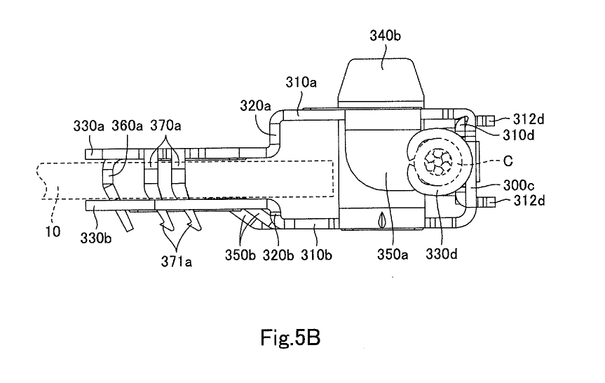

Next, a connector according to Embodiment 2 of the invention will be described with reference to FIGS. 4A to 6B. The connector shown in FIGS. 4A to 5B may be used for connection with a flexible conductive cloth 10 (conductor) as shown in FIG. 5B. The connector has a first conducting part 300a, a second conducting part 300b, a coupling part 300c, a cable connecting part 300d, and a plurality of rivets 400. These constituents of the connector will be described bellow in detail. FIGS. 4A to 4D show directions X, Y, and Z, wherein X is the length direction of the connector, Y is the front-rear direction of the connector, and Z is the height direction of the connector. The Y direction is perpendicular to the X direction, and the Z direction is perpendicular to the X and Y directions.

As shown in FIGS. 4A to 4D, the first conducting part 300a, the second conducting part 300b, and the coupling part 300c are made of a plate of electrically conductive metal. The second conducting part 300b includes a first plate 310b, a second plate 320b, a third plate 330b, a pair of lock pieces 340b (constituent of a lock mechanism), and a plurality of contacting portions 350b.

The first plate 310b is a generally rectangular plate extending in the X direction and to one side in the Y direction. A plurality of first ribs 311b and a plurality of second ribs 312b are provided on the central area of the upper face (the face facing the first conducting part) of the first plate 310b. The first ribs 311b and the second ribs 312b are formed by pressing portions of the first plate 310b. The first ribs 311b extend in parallel along the X direction. The second ribs 312b are located outside the X direction ends of the first ribs 311b and extend in the direction perpendicular to the first ribs 311b (i.e. in the Y direction). The first ribs 311b and the second ribs 312b serve to improve the first plate 310b in strength. The X direction ends of the first plate 310b are provided with a pair of rectangular cutaways 313b. The lock pieces 340b are joined to the inner edges of the cutaways 313b (the edges in the X direction). The lock pieces 340b are located on the inner side of the ends in the X direction (the width direction) of the first plate 310b.

The lock pieces 340b are rectangular plates bent upward with respect to the first plate 310b (one side in the Z direction). The lock pieces 340b have bendable portions 341b toward their ends. The bendable portions 341b extend in the Y direction. The bendable portions 341b have a smaller wall thickness than the portions other than the bendable portions 341b (remaining portions) of the lock pieces 340b. The lock pieces 340b are bendable inward along the bendable portions 341b. The lock pieces 340b may be bent at portions thereof other than the bendable portions 341b.

The second plate 320b is a rectangular plate joined to the first plate 310b and bent substantially at a right angle to the first plate 310b to extend toward the first conducting part 300a. The third plate 330b is a rectangular plate joined to the second plate 320b and extends in the X direction and to the one side in the Y direction (to the front side). The third plate 330b is bent substantially at a right angle to the second plate 320b so that the first plate 310b and the third plate 330b do not face each other.

A first rib 331b, a plurality of second ribs 332b, and a plurality of third ribs 333b are provided on the upper face (the face facing the first conducting part) of the third plate 330b. The first rib 331b, the second ribs 332b, and the third ribs 333b are formed by pressing portions of the third plate 330b. The first rib 331b extends in the X direction. The second ribs 332b are joined to the X direction ends of the first rib 331b and extend in the direction perpendicular to the first rib 331b (in the Y direction). The third ribs 333b are joined to the intermediate portion in the X direction of the first rib 331b and extend in the direction perpendicular to the first rib 331b (in the Y direction). The first rib 331b, the second ribs 332b, and the third ribs 333b serve to improve the third plate 330b in strength.

The third plate 330b is provided with a plurality of locking holes 334b in spaced relation to each other. The locking holes 334b are rectangular holes passing through the third plate 330b in the Z direction, and they are arranged in the positions corresponding to locking projections 360a and 370a (to be described) of the first conducting part 300a. The locking holes 334b correspond to the “locking holes” defined in the claims.

The first plate 310b, the second plate 320b, and the third plate 330b include the contacting portions 350b. The contacting portions 350b are located between the second ribs 332b and the third ribs 333b and between the third ribs 333b. The contacting portions 350b are resilient pieces formed by cutting and raising portions of the first plate 310b, the second plate 320b, and the third plate 330b upward. As shown in FIG. 4D, the contacting portions 350b are bent stepwise so that their upper faces of the distal portions (the face facing the first conducting part) are located closer to the first conducting part 300a than the upper face (the face facing the first conducting part) of the third plate 330b. The contacting portions 350b resiliently deformable to positions in which the upper faces of the distal portions of the contacting portions 350b are flush with the upper face of the third plate 330b. The upper faces of the distal portions of the contacting portions 350b are each provided with a plurality of projections 351b. The projections 351b are of quadrangular pyramid shape projecting toward the first conducting part 300a.

The first conducting part 300a includes a first plate 310a, a second plate 320a, a third plate 330a, a pair of lock holes 340a (constituent of the lock mechanism), a pair of movable parts 350a, a plurality of locking projections 360a, and a plurality of locking projections 370a.

The first plate 310a is a rectangular plate extending in the X direction and obliquely upward (in a direction between the one side in the Z direction and the one side in the Y direction). As shown in FIG. 4B, the lower end (the end on the other side (the other end) in the Z direction) of the first plate 310a is provided with three arms 311a in spaced relation to each other in the X direction. The movable parts 350a are joined to the X direction ends of the first plate 310a. The movable parts 350a are rectangular plates bent at right angles to the first plate 310a to extend toward the second conducting part 300b. The lock holes 340a are provided at opposite ends of the first plate 310a, more particularly in the positions corresponding to the lock pieces 340b of the second conducting part 300b. The lock holes 340a are rectangular holes passing through the first plate 310a and adapted to receive the lock pieces 340b. The lock holes 340a are located on the inner side of the ends in the X direction (the width direction) of the first plate 310a. Further, a plurality of first ribs 312a and a plurality of second ribs 313a are provided on the lower face (the face facing the second conducting part) of the first plate 310a. The first ribs 312a and the second ribs 313a are formed by pressing portions of the first plate 310a. The first ribs 312a are located between the lock holes 340a and extend in parallel along the X direction. The second ribs 313a are located on the outer sides of the lock holes 340a and extend in the direction perpendicular to the first ribs 312a (in the Y direction). The first ribs 312a and the second ribs 313a serve to improve the first plate 310a in strength.

The second plate 320a is a rectangular plate joined to the first plate 310a and is bent substantially at a right angle to the first plate 310a to extend toward the second conducting part 300b. The third plate 330a is a plate joined to the second plate 320a and extends in the X direction and obliquely upward. The third plate 330a is bent substantially at a right angle to the second plate 320a so that the first plate 310a and the third plate 330a do not face each other. The third plate 330a has a wider portion 331 a and a narrower portion 332a. The narrower portion 332a is joined to the wider portion 331a and has a smaller dimension in the X direction than the wider portion 331a. The third plates 330a and 330b are adapted to sandwich the conductive cloth 10 therebetween when they are in a closed position as described below.

The locking projections 360a are of pointed shape and joined to the end of the narrower portion 332a of the third plate 330a. The locking projections 360a can swing in accordance with the turning of the first conducting part 300a. As shown in FIG. 4D, the locking projections 360a are bent substantially at right angles to the third plate 330a, and they are of curved forms conforming to their swing tracks. The swing tracks of the locking projections 360a are indicated in dot-dash lines in FIG. 4D. The locking projections 370a are of pointed shape and joined to opposite ends in the X direction of the narrower portion 332a of the third plate 330a. The locking projections 370a can swing in accordance with the turning of the first conducting part 300a. As shown in FIG. 4D, the locking projections 370a are bent substantially at right angles to the third plate 330a, and they are of curved forms conforming to their swing tracks. The swing tracks of the locking projections 370a are indicated in dot-dash lines in FIG. 4D. The locking projections 370a are provided at their distal ends with barbs 371a. The locking projections 360a and 370a are arranged in the positions corresponding to the locking holes 334b in the second conducting part 300b (that is, in the central area and at the opposite ends of the first conducting part 300a). The locking projections 360a and 370a pass through the conductive cloth 10 and are received in the locking holes 334b when the first and second conducting parts 300a and 300b are located in the closed position. The barbs 371a can be locked in the locking holes 334b.

Further, a plurality of first ribs 333a and a plurality of second ribs 334a are provided on the lower face (the face facing the second conducting part) of the third plate 330a. The first ribs 333a and the second ribs 334a are formed by pressing portions of the third plate 330a. The first ribs 333a extend in parallel along the X direction. The second ribs 334a are located on the outer sides of the ends in the X direction of the first ribs 333a and extend in the direction perpendicular to the first ribs 333a. The first ribs 333a and the second ribs 334a serve to improve the first plate 310a in strength.

The coupling part 300c is a rectangular plate to couple the ends of the first and second conducting parts 300a and 300b such that the first and second conducting parts 300a and 300b are turnable from the closed position to an open position. The coupling part 300c is joined to the rear end (the other end in the Y direction) of the first plate 310b of the second conducting part 300b, and it is bent substantially at a right angle to the first plate 310b. At the upper end (one end in the Z direction) of the coupling part 300c, there are three arms 310c in the positions corresponding to the arms 311a of the first conducting part 300a. The arms 310c extend upward (to the one side in the Z direction) and are coupled to the arms 311a of the first conducting part 300a. The boundaries between the arms 310c and 311a are thin-walled. The boundaries serve as pivots on which the first and second conducting parts 300a and 300b turn (open and close) from the closed position to the open position. As shown in FIGS. 5A and 5B, the first and second conducting parts 300a and 300b in the closed position face each other substantially in parallel and securely sandwich the conductive cloth 10 therebetween. As shown in FIGS. 4A to 4D, the first and second conducting parts 100a and 100b in the open position are located away from each other, allowing the conductive cloth 10 to be released from therebetween.

The upper end of the coupling part 300c is provided with engaging recesses 320c, each being located between adjacent two of the arms 310c as shown in FIG. 4B. The lower end of the coupling part 300c is provided with two locking holes 330c in the positions corresponding to the two engaging recesses 320c. The middle portion of the coupling part 300c is provided with two attaching holes 340c in spaced relation to each other in the X direction. The attaching holes 340c pass through the thickness of the coupling part 300c.

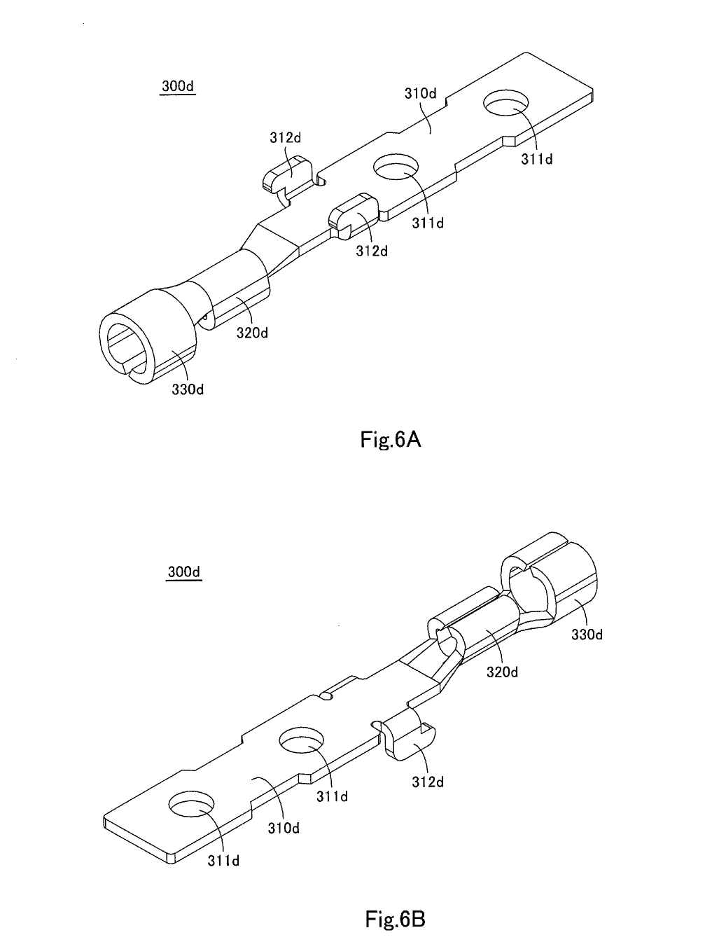

The cable connecting part 300d is a plate of electrically conductive metal fixed to the coupling part 300c. As shown in FIGS. 6A and 6B, the cable connecting part 300d has a fixed portion 310d, a connecting portion 320d, and a holding portion 330d. The fixed portion 310d is a rectangular plate of a smaller dimension in the X direction than the coupling part 300c. The fixed portion 310d is provided with two attaching holes 311d passing through the thickness of the fixed portion 310d. The attaching holes 311d are located in such positions as to communicate with the attaching holes 340c of the coupling part 300c. The attaching holes 311d and 340c receive the rivets 400, which fixes the fixed portion 310d to the front face of the coupling part 300c. In FIGS. 4A and 4B, the heads of the rivets 400 point inward (to the cable connecting part 300d side), but they may be point outward (to the coupling part 300c side).

The upper and lower ends (opposite ends in the Z direction) of the fixed portion 310d are provided with a pair of hooks 312d. The hooks 312d are generally L-shaped plates. The hooks 312d each include a basal portion, which is bent substantially at a right angle to the fixed portion 310d, and a distal portion, which extends to the connecting portion 320d side. One of the hooks 312d is engaged in one of the two engaging recesses 320c of the coupling part 300c, and the other hook 312d is engaged in one of the two locking holes 330c of the coupling part 300c.

The connecting portion 320d is a generally C-shaped plate joined to the fixed portion 310d, and it is of inside diameter slightly smaller than the outside diameter of a core C1 of a cable C. The connecting portion 320d is adapted to hold the core C1 of the cable C. The holding portion 330d is a generally C-shaped plate joined to the connecting portion 320d, and it is of inside diameter slightly smaller than the outside diameter of an insulative protective cover C2 that covers the core C1 of the cable C. The holding portion 330d is adapted to hold the protective cover C2 of the cable C.

Described in detail below are steps to assemble the connector configured as described above and to connect the connector to the connecting cable C. The first step is to prepare the cable connecting part 300d formed by pressing an electrically conductive metal plate. The cable connecting part 300d now have the connecting portion 320d and the holding portion 330d in planar form. The next step is to prepare the cable C, in which one end in the length direction of the protective cover C2 is peeled off to expose the core C1 from the protective cover C2. The exposed core C1 and the protective cover C2 are brought closer to the connecting portion 320d and the holding portion 330d, respectively. The connecting portion 320d is then bent in a generally C-shape and fixedly connected to the core C1. Likewise, the holding portion 330d is bent in a generally C-shape and fixed to the protective cover C2.

The next step is to prepare the first conducting part 300a, the second conducting part 300b, and the coupling part 300c, which are formed by pressing an electrically conductive metal plate. The hooks 312d of the fixed portion 310d of the cable connecting part 300d are brought into engagement with one of the engaging recesses 320c and one of the locking holes 330c of the coupling part 300c, thereby bringing the fixed portion 310d into contact with the front face of the coupling part 300c. In this state, the rivets 400 are inserted into the attaching holes 311d of the fixed portion 310d and then into the attaching holes 340c of the coupling part 300c, so that the fixed portion 310d of the cable connecting part 300d is fixed to the coupling part 300c. The core C1 of cable C is thus electrically connected to the first and second conducting parts 300a and 300b via the coupling part 100c.

Described below are the steps to connect the conductive cloth 10 to the connector assembled as described above. First, the first and second conducting parts 100a and 100b are brought into the open position. Then, the conductive cloth 10 is inserted between the first and second conducting parts 300a and 300b. The next step is to turn the first and second conducting parts 300a and 300b from the open position to the closed position, using the boundaries between the arms 310c and the arms 311a as pivots. Specifically, the first conducting part 300a (moving part) is turned so as to approach the second conducting part 300b (fixed part). The first and second conducting parts 300a and 300b are thus brought closer each other and securely sandwich the conductive cloth 10 therebetween.

When the first and second conducting parts 300a and 300b turn from the open position to the closed position, the locking projections 360a of the first conducting part 300a swing in accordance with the turning of the first conducting part 300a to stick into the conductive cloth 10. The locking projections 360a are then received into the locking holes 334b of the second conducting part 300b. The locking projections 370a swing in accordance with the turning of the first conducting part 300a to stick into the conductive cloth 10. The locking projections 370a are then engagingly received into the locking holes 334b of the second conducting part 300b. The contacting portions 350b of the second conducting part 300b are pressed by the conductive cloth 10 and resiliently deformed to the positions in which the upper face of the distal portions of the contacting portions 350b are flush with the upper face of the third plate 330b. As a result, the projections 351b on the distal portions of the contacting portions 350b resiliently contact the conductive cloth 10. The movable parts 350a swing in accordance with the turning of the first conducting part 300a to approach the connecting portion 320d of the cable connecting part 300d. The movable parts 350a then abut the connecting portion 320d of the cable connecting part 300d (see FIG. 5A). As a result, the connecting portion 320d is securely sandwiched between the movable parts 350a and the coupling part 300c. The lock pieces 340b of the second conducting part 300b are received into the lock holes 340a of the first conducting part 300a.

Thereafter, the lock pieces 340b are bent inward along the bendable portions 341b. The lock pieces 340b then abut the first conducting part 300a (specifically, the first plate 310a). Consequently, the first and second conducting parts 300a and 300b are locked while sandwiching the conductive cloth 10 therebetween.

In the connector as described above, the first and second conducting parts 300a and 300b are connected to the conductive cloth 10 by sandwiching the conductive cloth 10 therebetween to make the locking projections 360a and 370a pass through the conductive cloth 10. It is therefore easy to change the connection position s of the first and second conducting parts 300a and 300b with respect to the conductive cloth 10. In addition, as the locking projections 360a and 370a pass through the conductive cloth 10, there is no need to make large holes for attaching hooks in the conductive cloth 10. Therefore, there is no damaging of the electrodes in the conductive cloth 10 due to such hole-making, thereby improving the connection stability of the connector with respect to the conductive cloth 10.

Further, the connector has an improved tension strength with respect to the conductive cloth 10 because the locking projections 360a and 370a pass through the conductive cloth 10 to be received in the locking holes 334b of the second conducting part 300b. Further, the hooks 312d of the cable connecting part 300d are engaged with the associated engaging recess 320c and the associated locking hole 330c of the coupling part 300c. The connecting portion 320d of the cable connecting part 300d is sandwiched between the movable parts 350a and the coupling part 300c. These arrangements improving the fixing strength of the cable connecting part 300d with respect to the coupling part 300c, making the cable connecting part 300d more resistant to external load, and thereby improve the prying resistance of the cable connecting part 300d. The above arrangements also improve the tension strength of the cable C connected to the cable connecting part 300d. Also, as the hooks 312d of the cable connecting part 300d engaged into the engaging recess 320c and the locking hole 330c of the coupling part 300c, it is possible to reduce a load on the rivets 400, i.e. the part joining the cable connecting part 300d and the coupling part 300c.

Further, the locking projections 360a and 370a are of curved forms conforming to their swing tracks. It is therefore possible to reduce load on the conductive cloth 10 when the locking projections 360a and 370a stick into the conductive cloth 10.

Also, when the first and second conducting parts 300a and 300b sandwich the conductive cloth 10 therebetween (when they are in the closed position), the contacting portions 350b of the second conducting part 300b resiliently contact the conductive cloth 10 to press the conductive cloth 10 onto the first conducting part 300a. Therefore, the first and second conducting parts 300a and 300b have an improved retaining force and stable contact resistance values with respect to the conductive cloth 10. In addition, it is possible to increase the contact area with respect to the conductor 10 because the conductive cloth 10 as sandwiched between the first and second conducting parts 300a and 300b (in the closed position) is in abutment with the projections 351b of the contacting portions 350b. This abutment increases the contact area with respect to the conductor 10 and thereby stabilize the contact resistance value of the first and second conducting parts 300a and 300b with respect to the conductive cloth 10. Further, the spring constant of the contacting portions 350b can be changed by changing the shape of the contacting portions 350b. Therefore, the connector under vibration or shock is less likely to produce resonance with the contacting portions 350b.

Further, when the first and second conducting parts 300a and 300b are located in the closed position, the lock pieces 340b of the second conducting part 300b (i.e. the fixed part) are received in the lock holes 340a of the first conducting part 300a (i.e. the moving part). It is therefore possible to lock the first and second conducting parts 300a and 300b as sandwiching the conductive cloth 10 therebetween, simply by bending the lock pieces 340b into abutment with the first conducting part 300a. It is also possible to change the distance between the first and second conducting parts 300a and 300b and to change the pressure of the contacting portions 350b to the conductive cloth 10, simply by changing the bending positions of the lock pieces 340b according to the thickness dimension of the conductive cloth 10 which may greatly vary. Therefore, the connector can provide an appropriate contact pressure to the conductive cloth 10 according to the thickness dimension of the conductive cloth 10.

Still further, the lock pieces 340b are located on the inner sides of the ends in the X direction of the first plate 310b. The lock holes 340a are located on the inner sides of the ends in the X direction of the first plate 310a. The lock pieces 340b and the lock holes 340a are thus configured and provided in the second and first conducting part 300b and 300a, respectively, without substantially increasing the outer dimensions of the connector.

It should be noted that the connector of the invention is not limited to the above embodiments and may be modified in any manner within the scope of claims as detailed below.

In Embodiment 1, the first conducting part 100a includes the first plate 110a, the second plate 120a, the third plate 130a, the pair of first locking pieces 140a, the pair of second locking pieces 150a, the pair of third locking pieces 160a (constituent of the lock mechanism), the locking projections 170a and 180a, and the contacting portions 190a, while the second conducting part 100b includes the first plate 110b, the second plate 120b, the third plate 130b, the pair of first locking pieces 140b, the pair of second locking pieces 150b, and the pair of third locking pieces 160b (constituent of the lock mechanism). In Embodiment 2, the first conducting part 300a includes the first plate 310a, the second plate 320a, the third plate 330a, the pair of lock holes 340a (constituent of the lock mechanism), the pair of movable parts 350a, and the locking projections 360a and 370a, while the second conducting part 300b includes the first plate 310b, the second plate 320b, the third plate 330b, the pair of lock pieces 340b (constituent of the lock mechanism), and the contacting portions 350b. However, the first and second conducting parts of the invention may be modified in any manner as long as they are electrically conductive and adapted to sandwich a flexible conductor therebetween and at least one of the first and second conducting parts includes a locking projection. In addition, the first and second conducting parts are not limited to be press-formed and may also be formed e.g. by casting (e.g., aluminum die cast).

In Embodiment 1, the first conducting part 100a is fixed to the first body 200a by bringing the first and second locking pieces 140a and 150a into engagement with the locking holes 221a and the locking holes 211a, respectively, of the first body 200a. However, the first conducting part of the invention may be fixed to the first body by any other known means. For instance, the first conducting part may be fixed to the first body by providing locking pieces on the first body to be locked in locking holes provided in the first conducting part. The first conducting part of the invention may also be fixed to the first body by insert molding or outsert molding. The first conducting part of the invention may also be fixed to the first body with an adhesive. The fixing means of the second conducting part to the second body may also be modified in a similar manner to the fixing means of the first conducting part to the first body.

In Embodiment 1, the first conducting part 100a includes the locking projections 170a and 180a. In Embodiment 2, the first conducting part 300a includes the locking projections 360a and 370a. However, the locking projection of the invention maybe modified in any manner if it is provided in at least one of the first and second conducting parts, adapted to swing in accordance with the turning of the one of the conducting parts, adapted to pass through a conductor, and of a curved form conforming to a swing track thereof. The barbs 181a of the locking projections 180a and the barbs 371a of the locking projections 370a may be omitted. The barbs can be provided on the locking projections 170a and/or 360a. Each locking projection may be provided with a plurality of barbs.

In Embodiment 1, the second conducting part 100b is provided with the locking holes 132b adapted to receive the locking projections 170a and 180a. In Embodiment 2, the second conducting part 300b is provided with the locking holes 334b adapted to receive the locking projections 360a and 370a. However, the locking holes may be omitted. In this case, the locking projections are provided in the first conducting part so as not to abut the second conducting part when the first and second conducting parts are located in the closed position. In addition, the locking holes may be replaced with engaging recesses. If the locking projections are provided in both the first and second conducting parts, the locking holes or recesses may be provided in both the first and second conducting parts. If the locking projection is provided in the second conducting part, the locking hole or recess may be provided in the first conducting part. The locking hole/holes or recess/recesses may be omitted even if the locking projections are provided in both the first and second conducting parts or if the locking projection is provided in the second conducting part. In this case, the first and second conducting parts include locking projections adapted to not abut the second or first conducting parts, or the second conducting part includes a locking projection adapted to not abut the first conducting part. Locking hole/holes and locking recess/recesses may coexist in the first and/or second conducting parts.

In Embodiment 1, the first and second conducting parts 100a and 100b include the projections 131a, 191a, and 131b. In Embodiment 2, the projections 351b are provided on the distal portions of the contacting portions 350b of the second conducting part 300b. However, the projections may be omitted. Alternatively, only in one of the first and second conducting parts includes a projection or projections. In Embodiments 1 and 2, the projections are of quadrangular pyramid shapes, but projections may be of any other shapes (various convex shapes such as conical shape, polygonal pyramid shape, or cut-and-raised teeth as used in a grater). The first and second conducting parts may have a recess or recesses in place of the projections. The recess/recesses may be provided only in one of the first and second conducting parts. The recess/recesses may be of quadrangular pyramid shape. If the first and second conducting parts have a recess or recesses, the inner face/faces of the recess/recesses contact the conductor, increasing contact areas of the first and/or second conducting parts with the conductor and stabilizing their contact resistance values with respect to the conductive cloth. The first and second conducting parts may have both the projection/projections and the recess/recesses.

In Embodiment 2, the first conducting part 300a includes the first and second ribs 312a and 313a and the first and second ribs 333a and 334a, while the second conducting part 300b includes the first and second ribs 311b and 312b and the first, second, and third ribs 331b, 332b, and 333b. However, any of these ribs may be omitted. The ribs may be provided in one of the first and second conducting parts. In addition, the ribs may be replaced with a concave-convex face provided in at least one of the first and second conducting parts. The concave-convex face may be diamond cut-shaped, for example. The concave-convex face can also improve the strength of the at least one of the first and second conducting parts. The ribs may or may not be formed by pressing portions of the first or second conducting parts.

In Embodiment 1, the first conducting part 100a includes the contacting portions 190a. In Embodiment 2, the second conducting part 300b includes the contacting portions 350b. However, the contacting portions may be omitted. Alternatively, the contacting portions may be provided in at least one of the first and second conducting parts. In Embodiments 1 and 2, the contacting portions are resilient pieces formed by cutting and raising portions of an electrically conductive metal plate. However, the contacting portions may be modified to any configuration adapted to resiliently contact a conductor sandwiched by the first and second conducting parts. For instance, the contacting portions may be resilient pieces separately provided from the first and second conducting parts, or resilient bodies having electrical conductivity, such as coil springs and conductive rubbers. The projections provided on the distal portions of the contacting portions may be omitted.

In Embodiment 1, the coupling part 100c is configured such that the thin-walled boundaries between the arms 110c and 111a serves as pivots on which the first and second conducting parts 100a and 100b turn from the closed position to the open position. In Embodiment 2, the coupling part 300c is configured such that the thin-walled boundaries between the arms 310c and 311a serves as pivots on which the first and second conducting parts 300a and 300b turn from the closed position to the open position. However, the coupling part of the invention may be modified as long as it is adapted to couple the ends of the first and second conducting parts in a turnable manner from the closed position, in which the first and second conducting parts can sandwich the flexible conductor therebetween, to the open position, in which the first and second conducting parts can release the conductor; or as long as the coupling part is adapted to couple the ends of the first and second bodies in a turnable manner from the closed position, in which the first and second conducting parts can sandwich the flexible conductor therebetween, to the open position, in which the first and second conducting parts can release the conductor. For instance, the coupling part may include a hinge mechanism to couple the ends of the first and second, conducting parts or the ends of the first and second bodies in a turnable manner from the closed position to the open position. In addition, the coupling part of the configurations similar to those in Embodiments 1 and 2 may be used to couple the ends of the first and second bodies.

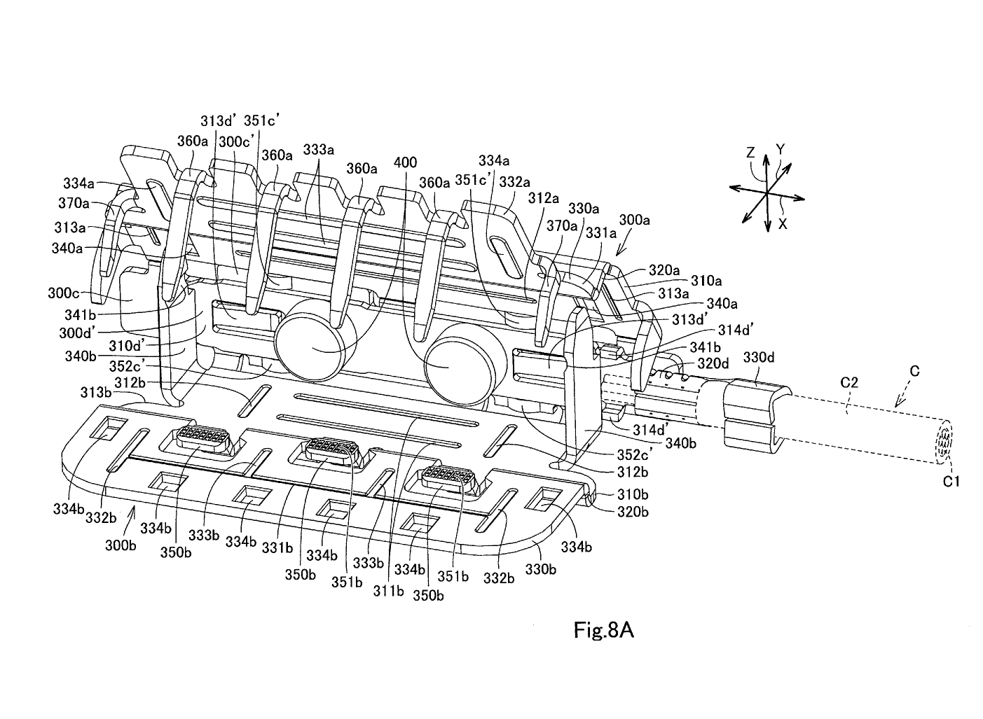

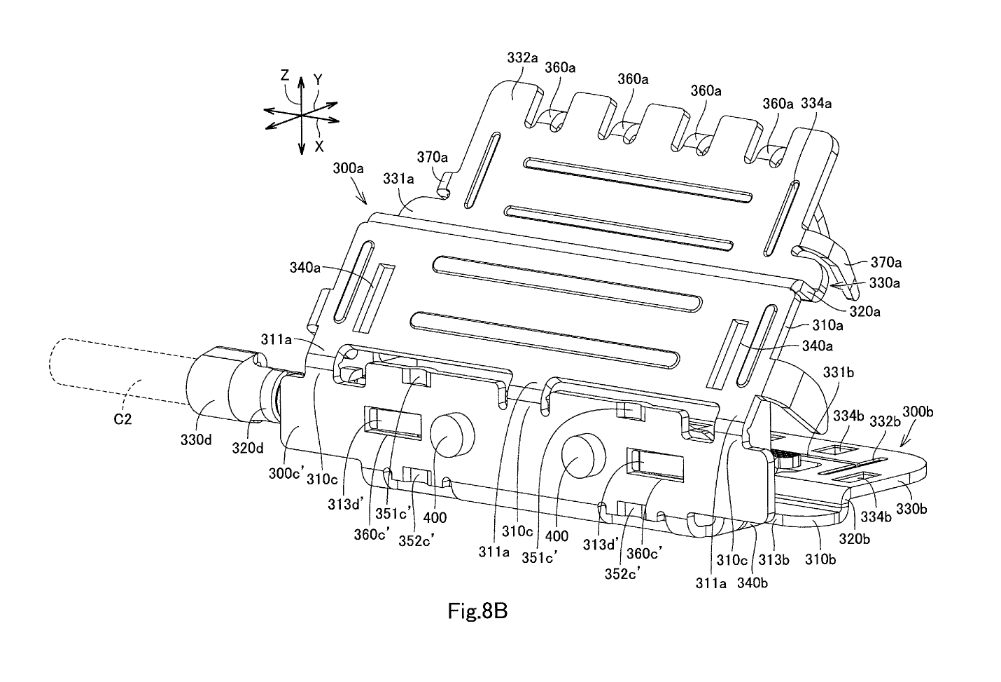

Alternatively, the coupling part may be configured like a coupling part 300c′ as illustrated in FIGS. 8A and 8B. Particularly, the upper end (one end in the Z direction) of the coupling part 300c′ is provided with a plurality of first guide projections 351c′, and the lower end (the other end in the Z direction) of the coupling part 300c′ is provided with a plurality of second guide projections 352c′. The first and second guide projections 351c′ and 352c′ project to one end side in the Y direction. The first guide projections 351c′ and the second guide projections 352c′ are spaced from each other in the Z direction. The distance between the first guide projections 351c′ and the second guide projections 352c′ is set to be slightly larger than the dimension in the Z direction of a fixed portion 310d′ of a cable connecting part 300d′. The fixed portion 310d′ is inserted between the first guide projections 351c and the second guide projections 352c to be guided to a fixing position with respect to the coupling part 300c′. The fixing position is the position in which attaching holes (not shown) in the coupling part 300c′ are aligned with and in communication with attaching holes (not shown) in the fixed portion 310d′. However, the fixing position may be set at any position. The rivets 400 are attached into the aligned attaching holes of the coupling part 300c′ and the fixed portion 310d′. The first guide projections 351c′ and the second guide projections 352c′ may be provided on the coupling parts of Embodiments 1 and/or 2. If the cable connecting part is fixed to the rear face of the coupling part, the first and second guide projections 351c′ and 352c′ should project to the other end side in the Y direction.

In Embodiment 1, the lock mechanism to maintain the first and second conducting parts 100a and 100b in the closed position includes the third locking pieces 160a with the lock lugs 161a of the first conducting part 100a, and the third locking pieces 160b with the lock lugs 161b of the second conducting part 100b. In Embodiment 2, the lock mechanism to maintain the first and second conducting parts 300a and 300b in the closed position includes the pair of lock holes 340a in the first conducting part 300a and the pair of lock pieces 340b of the second conducting part 300b. However, the lock mechanism may be omitted. Alternatively, the lock mechanism may be modified to any configuration adapted to lock the first conducting part to the second conducting part in the state where the first and second conducting parts sandwich the conductor therebetween (closed position).

For instance, the lock mechanism may be configured that the second conducting part 100b includes lock lugs to be locked in lock holes of the first conducting part 100a. Alternatively, the lock pieces 340b of Embodiment 2 may be formed without the bendable portions 341b. Alternatively, the lock pieces 340b may each have a plurality of bendable portions 341b. In this case, the lock pieces 340b may be bent along each of the bendable portions.

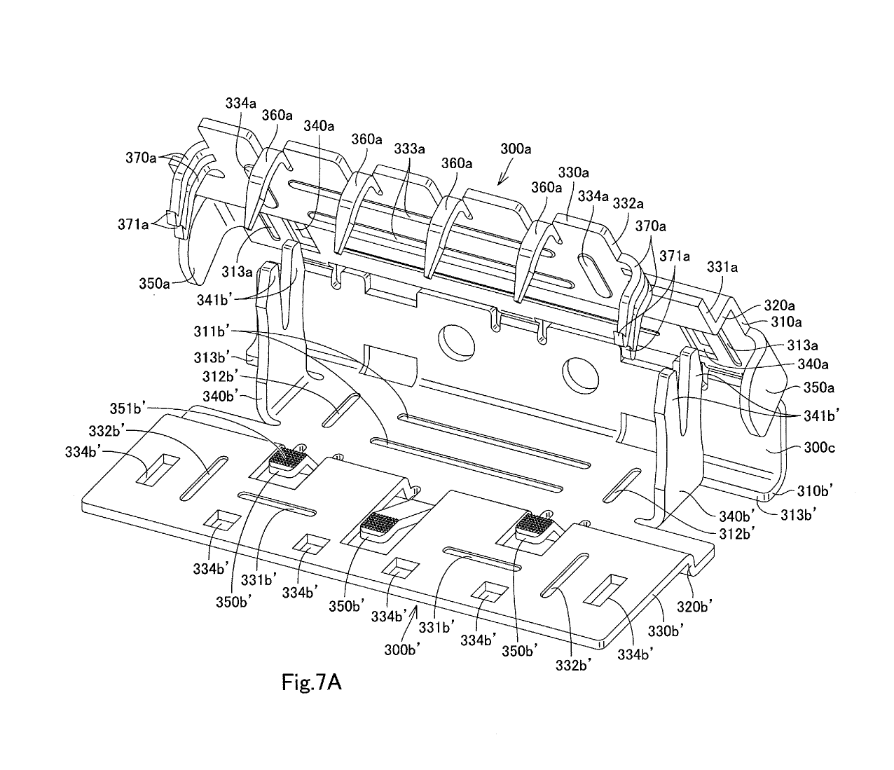

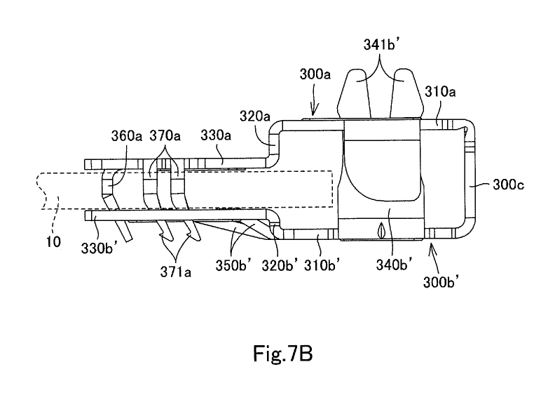

The lock mechanism may be configured as shown in FIGS. 7A and 7B. Particularly, a second conducting part 300b′ includes lock pieces 340b′ at the edges of cutaways 311b′ in a first plate 310b′, and the lock pieces 340b′ each bifurcate into two distal portions 341b′ and 341b′ (they are each of V shape). The distal portions 341b′ and 341b′ of the lock pieces 340b′ are adapted to be inserted into respective lock holes 340a in the first conducting part 300a to be plastically deformed in directions away from each other and engaged with the edges of the lock holes 340a. This configuration makes it easy to lock the first and second conducting parts 300a and 300b′ as sandwiching the conductive cloth 10 therebetween, simply by plastically deforming the distal portions 341b′ and 341b′ of the lock pieces 340b′ in the directions away from each other and engaging them with the edges of the lock holes 340a. It is also possible to change the distance between the first and second conducting parts 300a and 300b′ and to change the pressure of the contacting portions 350b′ to the conductive cloth 10, simply by changing the height position of the engagement of the distal portions 341b′ and 341b′ of the lock pieces 340b′ with respect to the edges of the lock holes 340a in accordance with the thickness dimension, which may greatly vary, of the conductive cloth 10. Therefore, the connector can provide an appropriate contact pressure to the conductive cloth 10 in accordance with the thickness dimension of the conductive cloth 10. The second conducting part 300b ′ may be configured, except for the above description, substantially the same as the second conducting part 300b of Embodiment 2.

FIGS. 7A and 7B also illustrate first ribs 311b′ of the first plate of the second conducting part, second ribs 312b′ of the first plate of the second conducting part, a second plate 320b′ of the second conducting part, a third plate 330b′ of the second conducting part, first ribs 331b′ of the third plate of the second conducting part, second ribs 312b′ of the third plate of the second conducting part, locking holes 334b′ of the second conducting part, and contacting portions 350b′ of the second conducting part. The cable connecting part 300d is not illustrated in FIGS. 7A and 7B. The lock pieces may each be trifurcated into distal ends (may each be of W-shaped). Also in this case, the outer two of the distal ends may be plastically deformed to be engaged with the edges of the lock holes in a similar manner to the bifurcated lock pieces.

In Embodiments 1 and 2, the cable connecting part is fixed to the coupling part. However, the cable connecting part may be omitted. The cable connecting part may be fixed to the front face or the rear face of the coupling part. In addition, the cable connecting part may consist of the connecting portion only. In other words, the holding portion may be omitted. The connecting portion may be modified in any manner as long as it is connected to at least one of the first and second conducting parts and connectable to a cable. Particularly, the connecting portion may be fixed or integrally provided to the first and/or second conducting parts. Alternatively, the connecting portion may be integrally provided in the coupling part if it is electrically conductive. In Embodiment 2, the hooks 312d of the cable connecting part 300d are engaged in the associated engaging recess 320c and the associated locking hole 330c of the coupling part 300c. However, the hooks, the engaging recess, and the locking hole may be omitted. Alternatively, the hooks may be engaged in the engaging recesses only or in the locking holes only of the coupling part. Alternatively, the hooks and the engaging recesses (or the locking holes) may be provided in both the cable connecting part and the coupling part of Embodiment 1. The hooks may be provided in the coupling part, and the engaging recesses (or the locking holes) may be provided in the cable connecting part.

FIGS. 8A and 8B illustrates a cable connecting part 300d′ including a fixed portion 310d′ provided with a pair of first stops 313d′ and a pair of second stops 314d′ in place of the hooks 312d. The first stops 313d′ (engaging portions) are resilient pieces extending in the X direction, formed by cutting out portions of the central area of the fixed portion 310d′ and bent to the coupling part 300c′ side. The first stops 313d′ are spaced from each other in the X direction. The central area of the coupling part 300c′ is formed with locking holes 360c′ in spaced relation to each other in the X direction. The locking holes 360c′ are of shape slightly larger than the outer shapes of the first stops 313d′. The second stops 314d′ are generally L-shaped plates provided at the upper and lower ends (opposite ends in the Z direction) of the fixed portion 310d′ and are bent to the lock pieces 340b side of the second conducting part 300b. When the fixed portion 310d′ is inserted between the coupling part 300c′ and the lock pieces 340b and is then guided by the first guide projections 351c′ and the second guide projections 352c′ to reach the fixing position (i.e., when the cable connecting part 300d′ is located in the fixing position), the first stops 313d′ are engaged in the locking holes 360c′, and the second stops 313d′ abut the lock piece 340b. The fixed portion 310d′ is thus positioned and held in the fixing position with respect to the coupling part 300c′. In this state, the fixed portion 310d′ is fixed to the coupling part 300c′ with the rivets 400. It should be noted the cable connecting part may include the first stops 313d′ only or the second stops 314d′ only. Also, the first guide projections 351c′ and the second guide projections 352c′ may be omitted, in which case the cable connecting part 300d′ can be positioned in the fixing position with respect to the coupling part 300c′ by bringing the first stops 313d′ into engagement with the locking holes 360c′ and/or by bringing the second stops 314d′ into abutment with the lock pieces 340b. Conversely, the first stops 313d′ and the second stops 314d′ may be omitted, in which case the first guide projections 351c′ and the second guide projections 352c′ may guide the fixed portion 310d′ to the fixing position. The second guide projections 352c′ may be adapted to abut the respective lock pieces 340b. The first stops 313d′ may be provided in the coupling part, while the locking holes 360c′ may be provided in the cable connecting part. The locking holes 360c′ may be replaced with engaging recesses.

In Embodiment 2, the first plate 310a includes the movable parts 350a. However, any of the movable parts may be omitted. The movable parts may be any movable part provided in at least one of the first and second conducting parts and adapted to approach and abut the connecting portion of the cable connecting part so as to sandwich the connecting portion between the movable parts and the coupling part when the first and second conducting parts turn from the open position to the closed position. The movable parts may be provided in at least one of the first and second conducting parts of Embodiment 1.

In Embodiment 1, the first and second bodies 200a and 200b are fixed to the first and second conducting parts 100a and 100b, respectively. However, the first and second bodies may be omitted. In addition, in Embodiment 1, the first and second bodies 200a and 200b are blocks of the same shape and made of insulating resin, but the invention is not limited to this. That is, the first and second bodies may have different shapes and are not required to have insulation properties. Further, the first and second bodies may be made of a material other than insulating resin but may still have insulation properties. For instance, the first and second bodies may be made of a metal and an insulating film coating the outer surface of the metal.

In Embodiment 1, the first body 200a includes the abutments 250a and 260a, and the second body 200b includes the abutments 250b and 260b. However, any of the abutments may be omitted. The abutments may be any abutment provided in at least one of the first and second bodies and adapted to abut the other of the first and second bodies when the first and second conducting parts sandwich the conductor therebetween, thereby creating a predetermined clearance between the first and second conducting parts.

In Embodiment 1, the first arm 270a is joined to the rear end of the abutment 250a and extends in the width direction of the first body 200a (in the second direction). However, the first arm may be omitted. Alternatively, the first arm may be modified in any manner as long as it is provided at the first end in a first direction of the first body and extends in a second direction perpendicular to the first direction. The first arm 270b of the second body 200b may also be omitted or modified in a similar manner to the first arm 270a.

In Embodiment 1, the second arm 280a is joined to the rear end of the base 210a, the wall 240a, and the abutment 260a and extends in the width direction of the first body 200a (in the second direction). However, the second arm may be omitted. In addition, the second arm may be modified in any manner as long as it is provided at the second end in the first direction of the first body, extends in the second direction perpendicular to the first direction, and has a recess. The second arm 280b of the second body 200b may be omitted or modified in a similar manner to the second arm 280a.

The recesses in the second arms of the first and second bodies of the same shape may be any recesses one of which can receive the first arm of the second body when the first and second conducting parts are located in the open position, and another of which can be used as an accommodating recess to accommodates at least one of the connecting portion, the holding portion, and the cable. If the second arms include the recesses only, it preferable that the recesses pass through the second arms in the first direction.

Embodiments 1 and 2 and the above modifications have been described for describing examples of the material, shape, size, number, and arrangement of the respective constituents of the connectors, which may be modified in any manner as long as they can provide similar functions. Embodiments 1 and 2 are concerned only with a conductive cloth as an example of the flexible conductor. However, the conductor may be an electric carpet with electrodes on its surface, a conductive sheet, a locating tape, etc.

### REFERENCE SIGNS LIST

100a: First conducting part
110a: First plate
120a: Second plate
130a: Third plate
131a: Projection
140a: First locking piece
150a: Second locking piece
160a: Third locking piece (constituent of lock mechanism)
161a: Lock lug
170a: Locking projection
180a: Locking projection
181a: Barb
190a: Contacting portion
191a: Projection
100b: Second conducting part
110b: First plate
120b: Second plate
130b: Third plate
131b: Projection
132b: Locking hole
133b: Hole
140b: First locking piece
150b: Second locking piece
160b: Third locking piece (constituent of lock mechanism)
161b: Lock hole
100c: Coupling part
100d: Cable connecting part
110d: Fixed portion
120d: Connecting portion
130d: Holding portion
200a: First body
210a: Base
220a: Stand
230a: Wall
240a: Wall
250a: Abutment
260a: Abutment
270a: First arm
280a: Second arm
281a: First recess (recess in the second arm)
282a: Second recess
200b: Second body
210b: Base
220b: Stand
230b: Wall
240b: Wall
250b: Abutment
260b: Abutment
270b: First arm
280b: Second arm
281b: First recess (recess in the second arm)
282b: Second recess
300a: First conducting part
310a: First plate
311a: Arm
312a: First rib
313a: Second rib
320a: Second plate
330a: Third plate
331a: Wider portion
332a: Narrower portion
333a: First rib
334a: Second rib
340a: Lock hole
350a: Movable part
360a: Locking projection
370a: Locking projection
371a: Barb
300b: Second conducting part
310b: First plate
311b: First rib
312b: Second rib
320b: Second plate
330b: Third plate
331b: First rib
332b: Second rib
333b: Third rib F
334b: Locking hole
340b: Lock piece
350b: Contacting portion
351b: Projection
300c: Coupling part
320c: Engaging recess
330c: Locking hole
300d: Cable connecting part
310d: Fixing portion
312d: Hook
320d: Connecting portion
330d: Holding portion
C: Cable
10: Conductive cloth

1. A connector comprising:
first and second conducting parts; and
a coupling part to couple ends of the first and second conducting parts to allow the first and second conducting parts to turn from a closed position, in which the first and second conducting parts sandwich therebetween a conductor having flexibility, to an open position, in which the first and second conducting parts release the conductor,
wherein at least one of the first and second conducting parts includes a locking projection, the locking projection being configured to swing in accordance with the turning of the one of the conducting parts and pass through the conductor, and
wherein the locking projection is of a curved form conforming to a swing track of the locking projection.

2. The connector according to claim 1, further comprising:
a first body with insulation properties, configured to be fixed to the first conducting part and cover the first conducting part; and
a second body with insulation properties, configured to be fixed to the second conducting part and cover the second conducting part.

3. A connector comprising:
first and second conducting parts;
a first body fixed to the first conducting part;
a second body fixed to the second conducting part; and
a coupling part to couple ends of the first and second bodies to allow the first and second conducting parts to turn from a closed position, in which the first and second conducting parts sandwich therebetween a conductor having flexibility, to an open position, in which the first and second conducting parts release the conductor,
wherein at least one of the first and second conducting parts includes a locking projection, the locking projection being configured to swing in accordance with the turning of the one of the conducting parts and pass through the conductor, and
wherein the locking projection is of a curved form conforming to a swing track of the locking projection.

4. The connector according to claim 1,
wherein at least the other one of the first and second conducting parts includes a locking hole or recess to receive the locking projection.

5. The connector according to claim 1,
wherein at least one of the first and second conducting parts includes a contacting portion configured to resiliently contact the conductor as sandwiched by the first and second conducting parts.

6. The connector according to claim 5,
wherein the one of the conducting parts is made of an electrically conductive metal plate,
wherein the contacting portion is a resilient piece formed by cutting and raising a portion of the metal plate.

7. The connector according to claim 2,
wherein one of the first and second bodies includes an abutment to create a predetermined clearance between the first and second conducting parts by abutting the other one of the first and second bodies with the first and second conducting parts sandwiching the conductor therebetween.

8. The connector according to claim 2, further comprising a connecting portion connected to at least one of the first and second conducting parts and connectable to a cable.

9. The connector according to claim 8, further comprising a holding portion configured to hold the cable.

10. The connector according to claim 8, wherein
the coupling part is electrically conductive, and
the connector further comprises a cable connecting part configured to be fixed to the coupling part, the cable connecting part including the connecting portion.

11. The connector according to claim 10, further comprising a movable part provided in at least one of the first and second conducting parts, wherein
the movable part is configured to approach and abut the connecting portion of the cable connecting part when the first and second conducting parts turn from the open position to the closed position, and
abutment of the movable part on the connecting portion causes the connecting portion of the cable connecting part to be sandwiched between the movable part and the coupling part.

12. The connector according to claim 10, wherein
at least one of the cable connecting part and the coupling part includes a hook, and
the other of the cable connecting part and the coupling part includes a locking hole or recess engageable with the hook.

13. The connector according to claim 10, wherein
at least one of the cable connecting part and the coupling part includes a first stop,
the other of the cable connecting part and the coupling part includes a locking hole or recess engageable with the first stop.

14. The connector according to claim 10, further comprising:
a lock mechanism configured to lock the first conducting part to the second conducting part with the first and second conducting parts sandwiching the conductor therebetween, the lock mechanism including:
a lock hole or recess provided in one of the first and second conducting parts, and
a lock piece provided in the other one of the first and second conducting parts and configured to be received in the lock hole or recess, and
wherein the cable connecting part includes a second stop to abut the lock piece.

15. The connector according to claim 10, wherein
the coupling part includes first and second guide projections in spaced relation to each other, the first and second guide projections being configured to receive the cable connecting part therebetween to guide the cable connecting part to a fixing position with respect to the coupling part.

16. The connector according to claim 8, wherein
the first and second bodies have a same shape and are made of an insulating resin,
the first and second bodies each include:
a first end in a first direction,
a second end on the opposite side of the first end in the first direction,
a first arm being provided at the first end and extending in a second direction perpendicular to the first direction, and
a second arm being provided at the second end and extending in the second direction,
the second arm is provided with a recess, and
the recess in the second arm of the second body is configured to accommodate at least one of the connecting portion, the holding portion, and the cable.

17. The connector according to claim 1,
wherein at least one of the first and second conducting parts includes at least one of a projection and a recess contactable with the conductor.

18. The connector according to claim 17,
wherein the at least one of the projection and the recess is of a quadrangular pyramid shape.

19. The connector according to claim 1,
wherein the locking projection comprises a plurality of locking projections provided at the center and opposite ends of the first conducting part.

20. The connector according to claim 1,
wherein the locking projection is provided with a barb.

21. The connector according to claim 1,
wherein at least one of the first and second conducting parts include a rib or a concave-convex face.

22. The connector according to claim 1, further comprising a lock mechanism configured to lock the first conducting part to the second conducting part with the first and second conducting parts sandwiching the conductor therebetween.

23. The connector according to claim 22,
wherein the lock mechanism includes:
a lock lug provided in one of the first and second conducting parts, and
a lock hole or recess provided in the other one of the first and second conducting parts to lock the lock lug therein with the first and second conducting parts sandwiching the conductor therebetween.

24. The connector according to claim 22,
wherein the lock mechanism includes:
a lock hole or recess provided in one of the first and second conducting parts, and
a lock piece provided in the other one of the first and second conducting parts and received in the lock hole or recess, the lock piece being bendable.

25. The connector according to claim 24, wherein
the lock piece includes a bendable portion and a remaining portion excluding the bendable portion, the bendable portion having a smaller wall thickness than the remaining portion.

26. The connector according to claim 24, wherein
the lock hole or recess is disposed inward of widthwise ends of the one of the first and second conducting parts,
the lock piece is disposed inward of widthwise ends of the other one of the first and second conducting parts.

27. The connector according to claim 22, wherein
the lock mechanism includes:
a lock hole provided in one of the first and second conducting parts, and
a lock piece provided in the other one of the first and second conducting parts to be inserted into the lock hole, and
the lock piece bifurcates or trifurcates into distal portions that are plastically deformable in directions away from each other and engageable with an edge of the lock hole.

28. The connector according to claim 27, wherein
the lock hole is disposed inward of widthwise ends of the one of the first and second conducting parts,
wherein the lock piece is disposed inward of widthwise ends of the other one of the first and second conducting parts.
